(19) United States
(12) Patent Application Publication
(10) Pub. No.: US 2016/0093225 A1
(43) Pub. Date: Mar. 31, 2016

(54) LANDING SYSTEM FOR AN AIRCRAFT

(71) Applicant: BAE SYSTEMS AUSTRALIA LIMITED, Edinburgh, South Australia (AU)

(72) Inventors: Paul David Williams, Richmond, Victoria (AU); Michael Ross Crump, Richmond, Victoria (AU); Kynan Edward graves, Richmond, Victoria (AU)

(73) Assignee: BAE SYSTEMS AUSTRALIA LIMITED, Edinburgh, South Australia (AU)

(21) Appl. No.: 14/784,986

(22) PCT Filed: Apr. 16, 2014
(86) PCT No.: PCT/AU2014/050016

§ 371 Date: Oct. 16, 2015

(30) Foreign Application Priority Data
Apr. 16, 2013 (AU) 2013901332
Apr. 16, 2013 (AU) 2013901333

(51) Int. Cl. G08G 5/02; G06T 7/00; G06K 9/00

(52) U.S. Cl. CPC G08G 5/025; G06K 9/00637; G06K 9/00651; G06T 7/0042; G06T 7/0085; G06T 2207/10032

(57) ABSTRACT

A landing system of an aircraft, including: a site selector to select a candidate site using geographical reference point data for the site and current navigation data for the aircraft; a path generator to generate (a) a survey route within the vicinity of said candidate site using said geographical reference point data for the site, and (b) a route to said survey route and; a camera system to obtain images of the candidate site when said aircraft flys said survey route; a site detector controller to process the images to confirm the site by determining the images are of at least part of the candidate site; a tracker to track the site, once confirmed, relative to the aircraft based on the images to verify, and provide navigation data on, the candidate site; and a navigation and guidance system to land the aircraft on the site once the candidate site is verified using the navigation data.

### FIELD

The present invention relates to a landing system for an aircraft. In particular, the system may be used for autonomous recovery of an aircraft, such as an unmanned aerial vehicle (UAV). One aspect of the inventions relates to a controller of an aircraft to process images obtained by the aircraft to detect a landing site for the aircraft.

### BACKGROUND

Unmanned aerial vehicles (UAVs) rely on considerable ground infrastructure to ensure they are able to successfully operate and return to a runway from which the vehicle has taken off. Whilst a UAV flight computer may perform tasks for flying the aircraft, human operators are typically required to plan and undertake flight missions and control ground infrastructure is needed to recover and return an aircraft when issues arise. Circumstances can also arise where the aircraft cannot be returned to its designated airfield, and the UAV must be discarded at considerable cost. Whenever a UAV crashes, there is the added risk of loss of human life.

The requirement for takeoff and landing from a specific runway further limits the operational range of a UAV. Complex no fly areas also pose a difficulty as flying through no fly areas can result in catastrophic collisions, such as with elevated terrain.

For example, some operational UAVs have a fully automatic takeoff and landing capability, but the landing phase is usually carried out using a combination of pre-surveyed runways with known landing waypoints, an accurate height sensor for determining height above ground, and a differential GPS. These requirements can severely limit the use of modern UAV technology.

There are several examples of unplanned mission events that can lead to a UAV operator needing to land the aircraft as soon as possible, such as: engine performance problems; extreme weather conditions; bird strike or attack damage; and flight control problems related to malfunctioning hardware. In current systems, these situations can easily lead to the complete loss of the aircraft. The operator must either attempt a recovery to a mission plan alternate runway, or in the worst case, undertake a controlled ditching. Most modern UAV control systems allow multiple alternate landing sites to be specified as part of the mission plan. However, the problem with these alternate landing sites is that they require the same level of a priori knowledge (i.e., accurate survey) and support infrastructure as the primary recovery site. Therefore, this generally limits the number and location of the alternate landing sites. This is due to the amount of time and manpower required to setup, maintain, and secure the sites. The combined cost/effort and low probability of use detracts from the willingness to establish alternates. As mission requirements become more complex, it may not be possible for the aircraft to reach one of its alternate landing runways, and controlled ditching may result in considerable loss and damage.

Even for manned aircraft, it can be difficult for a pilot to determine whether a potential landing site is suitable for the aircraft to land on. This is particularly so for difficult weather conditions where visibility is low or where an emergency situation has arisen.

It is desired to address the above or at least provide a useful alternative. In particular, it is desired to preferably provide a landing system of an aircraft that is able to confirm and land at a landing site (e.g. a runway, aircraft carrier flight deck or helipad) autonomously without any external support, such as from ground based systems.

### SUMMARY

At least one embodiment of the present invention provides a landing system of an aircraft, including:
a site detector controller to process images obtained by the aircraft to extract feature data of a candidate landing site, and process the feature data to confirm the candidate site is a landing site;
a navigation system; and
a tracker to track the candidate site, once confirmed, using said feature data to generate a track of the candidate site relative to the aircraft, and couple the track to the navigation system to land the aircraft, when the tracker validates the candidate site as said landing site.

The landing system may include a site selector to select said candidate site using geographical reference point data for the candidate site and current navigation data generated by the navigation system for the aircraft;
a path generator to generate (a) a survey route within the vicinity of said candidate site using said geographical reference point data for the site, and (b) a route to said survey route; and
a camera system to obtain said images of the candidate site when said aircraft flies said survey route.

Advantageously, the path generator may route the aircraft to avoid no fly areas.

At least one embodiment of the present invention provides a landing site detector of an aircraft, including a controller to process images obtained by the aircraft on a survey route of a candidate landing site, and extract feature data of the candidate site to confirm the site is a known landing site.

At least one embodiment of the present invention provides an autonomous recovery process, executed by a landing system of an aircraft, including:
determining that the aircraft needs to land;
selecting a landing site;
generating a survey route in the vicinity of the landing site;
generating a route to take the aircraft from its current position to said vicinity of the landing site;
controlling a camera of the aircraft when flying said survey route to obtain images of at least part of the landing site;
processing the images to extract features of said landing site to confirm said landing site.
generating a track of the confirmed landing site using said features; and
inserting the track into a navigation system of the aircraft when the track corresponds to constraints for landing site to validate the landing site.

### DESCRIPTION OF THE DRAWINGS

Preferred embodiments of the present invention are hereinafter described, by way of example only, with reference to the accompanying drawings, wherein:

FIG. 1 is a subsystem decomposition of preferred embodiments of a landing system of an aircraft;

FIG. 2 is an architecture diagram of an embodiment of a flight control computer for the aircraft;

FIG. 3 is a block diagram of components of the control computer;

FIG. 4 is schematic diagram of the relationship between components of the control computer;

FIG. 5 is a flowchart of an autonomous recovery process of the landing system;

FIG. 6 is an example ERSA airfield data for West Sale Aerodrome;

FIG. 7 is a diagram for computation of time of flight using great-circle geometry;

FIG. 8 is an example of ERSA airfield reference points;

FIG. 9 is a diagram of survey route waypoint geometry;

FIG. 10 is a flowchart of a survey route generation process;

FIG. 11 is a diagram of standard runway markings used to classify the runway;

FIG. 12 is a diagram of runway threshold marking geometry;

FIG. 13 is a pinhole camera model used to covert pixel measurements into bearing/elevation measurements in measurement frame;

FIG. 14 is a diagram of coordinate frames used for tracking;

FIG. 15 is a diagram of runway geometry corner definitions;

FIG. 16 is a diagram of the relationship between adjustable crosswind, C, and downwind, D, circuit template parameters; and

FIG. 17 is a diagram of dynamic waypoints used during landing.

### DETAILED DESCRIPTION

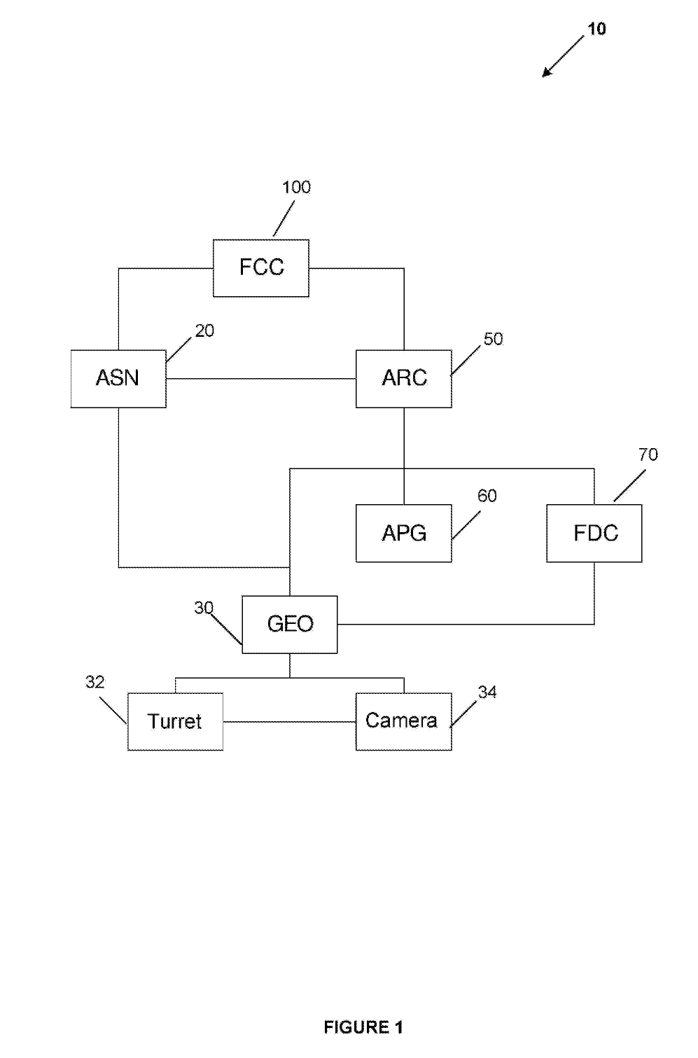

A landing system 10, as shown in FIG. 1, of an aircraft (or a flight vehicle) provides an autonomous recovery (AR) system 50, 60, 70 for use on unmanned aerial vehicles (UAVs). The landing system 10 includes the following subsystems:
1) A Flight Control Computer (FCC) 100 for managing flight vehicle health and status, performing waypoint following, primary navigation, and stability augmentation. The navigation system used by the FCC 100 uses differential GPS, and monitors the health of an ASN system 20.
2) An All-Source Navigation (ASN) system 20 for providing a navigation system for use by the FCC 100. The ASN 20 is tightly linked to the autonomous recovery (AR) system 50, 60, 70 of the aircraft in that runway tracking initialised by the AR system is ultimately performed inside the ASN 20 once the initial track is verified. As described below, establishing independent tracks or tracking of the landing site, confirming or verifying the position of the site relative to vehicle using the tracks, and then coupling or fusing the tracking to the navigation for subsequent processing by the ASN 20 is particularly advantageous for landing, particularly on a moving site. The ASN is also described in Williams, P., and Crump, M., All-source navigation for enhancing UAV operations in GPS-denied environments. Proceedings of the 28^{th} International Congress of the Aeronautical Sciences, Brisbane, September 2012 (“the ASN paper”) herein incorporated by reference.
3) A Gimbaled Electro-Optical (GEO) camera system 30 for capturing and time-stamping images obtained using a camera 34, pointing a camera turret 32 in the desired direction, and controlling the camera zoom.
4) An Automatic Path Generation (APG) system 60 for generating routes (waypoints) for maneuvering the vehicle through no-fly regions, and generating return to base (RTB) waypoints. This subsystem 60 is also described in Williams, P., and Crump, M., Auto-rousing system for UAVs in complex flight areas, Proceedings of the 28^{th} International Congress of the Aeronautical Sciences, Brisbane, September 2012 (“the Routing paper”) herein incorporated by reference.
5) An Autonomous Recovery Controller (ARC) system 50 for controlling the health and status of an autonomous recovery process, runway track initialization and health monitoring, and real-time waypoint updates. The ARC 50 controls independent tracking of the landing site until the site is verified and then transforms the track for insertion, coupling or fusing into the navigation system (e.g. the ASN 20) used by the aircraft. The runway track can include four corner points (extents) of the runway and associated constraints.
6) A Feature Detection Controller (FDC) system 70 for performing image processing, detecting, classifying, and providing corner and edge data from images for the ARC 50. The FDC is also described in Graves, K., Visual detection and classification of runways in aerial imtagery, Proceedings of the 28th International Congress of the Aeronautical Sciences, Brisbane, September 2012.
7) A Gimbaled Camera 34, and a camera turret 32 provided by Rubicon Systems Design Ltd to control the position of the camera 34.

The ASN, APG, ARC and FDC subsystems 20, 50, 60, 70 are housed on a Kontron CP308 board produced by Kontron AG, which includes an Intel Core-2 Duo processor. One core of the processor is dedicated to running the ASN system 20, and the second core is dedicated to running the AR system 50, 60, 70. In addition, inputs and outputs from all processes are logged on a solid state computer memory of the board. The GEO subsystem 30 is housed and runs on a Kontron CP307 board provided by Kontron AG, and manages control of the turret 32 and logging of all raw imagery obtained by the camera 34. The subsystems 20, 30, 50, 60, 70 may use a Linux operating system running a real time kernel and the processes executed by the sub-systems can be implemented and controlled using C computer program code wrapped in C++ with appropriate data message handling computer program code, and all code is stored in computer readable memory of the CP308 and CP307 control boards. The code can also be replaced, at least in part, by dedicated hardware circuits, such as field programmable gate arrays (FPGAs) or application specific integrated circuits (ASICs), to increase the speed of the processes.

### The Flight Control Computer

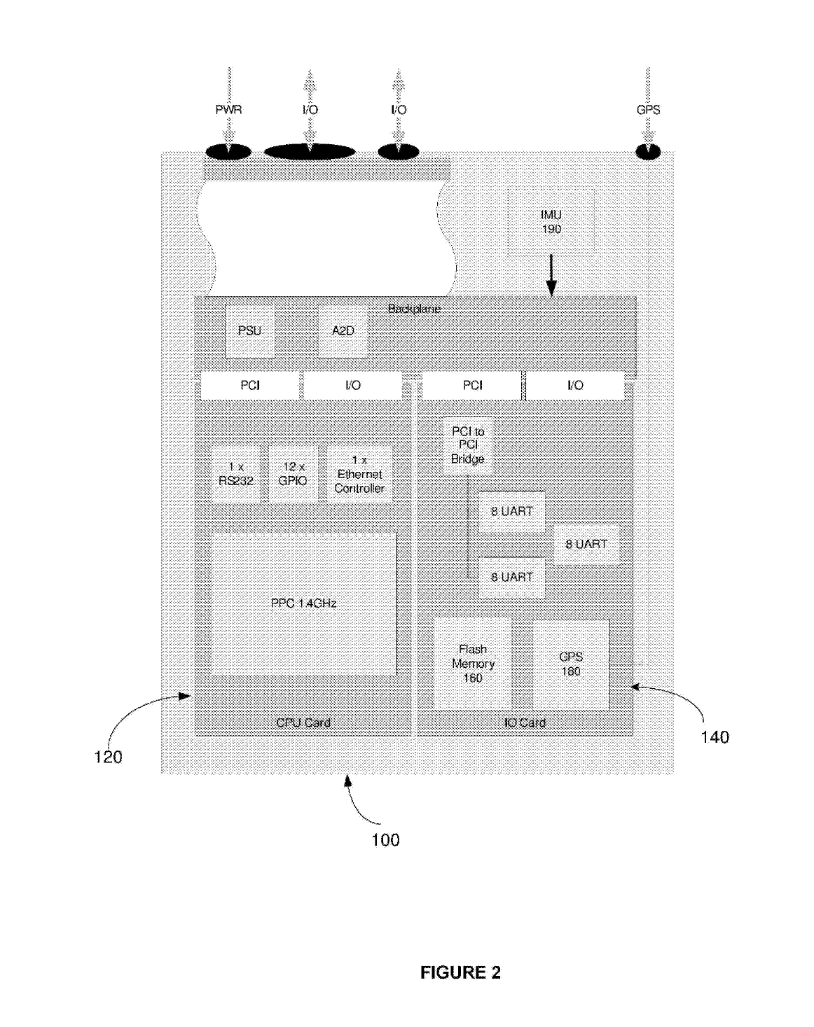

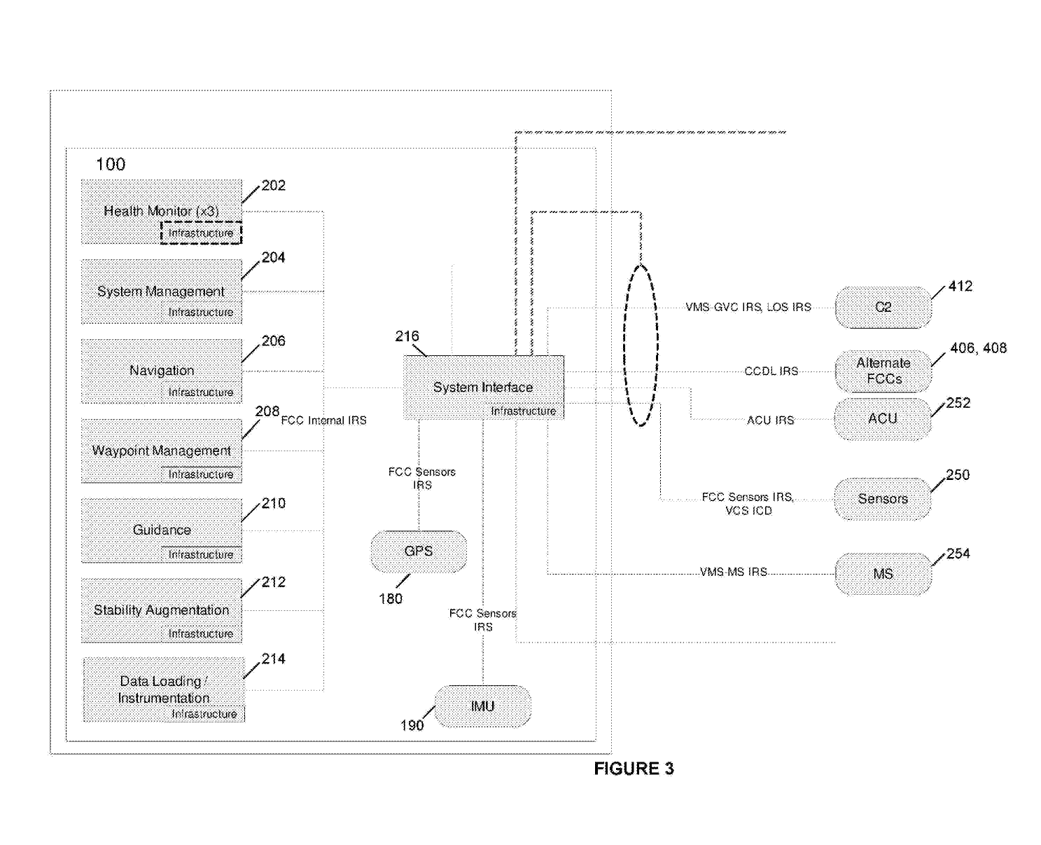

The flight control computer (FCC) 100, as shown in FIGS. 2 and 3, accepts and processes input sensor data from sensors 250 on board the vehicle. The FCC 100 also generates and issues command data for an actuator control unit (ACU) 252 to control various actuators on board the vehicle in order to control movement of the vehicle according to a validated flight or mission plan. The ACU 252 also provides response data, in relation to the actuators and the parts of the vehicle that the actuators control, back to the computer 100 for it to process as sensor data. The computer 100 includes Navigation. Waypoint Management and Guidance components 206, 208 and 210 to control a vehicle during phases of the flight plan. The computer 100, as shown in FIG. 2, includes a single board CPU card 120, with a Power PC and input/output interfaces (such as RS232, Ethernet and PCI), and an I/O card 140 with flash memory 160, a GPS receiver 180 and UART ports. The computer 100 also houses an inertial measurements unit (IMU) 190 and the GPS receiver (e.g. a Novatel OEMV1) 180 connects directly to antennas on the vehicle for a global positioning system, which may be a differential or augmented GPS.

The FCC 100 controls, coordinates and monitors the following sensors 250 and actuators on the vehicle:
(i) an air data sensor (ADS) comprising air pressure transducers,
(ii) an accurate height sensor (AHS). e.g. provided by a ground directed laser or sonar.
(iii) a weight on wheels sensor (WoW),
(iv) a transponder, which handles communications with a ground vehicle controller (GVC),
(v) the electrical power system (EPS),
(vi) primary flight controls, such as controls for surfaces (e.g. ailerons, rudder, elevators, air brakes), brakes and throttle,
(vii) propulsion systcm, including
   (a) an engine turbo control unit (TCU).
   (b) an engine management system (EMS),
   (c) an engine kill switch,
   (d) carburettor heater.
   (e) engine fan,
   (f) oil fan
(viii) fuel system,
(ix) environmental control system (ECS) comprising aircraft temperature sensor, airflow valves and fans.
(x) Pitot Probe heating,
(xi) external lighting, and
(xii) icing detectors.

The actuators of (v) to (xi) are controlled by actuator data sent by the FCC 100 to at least one actuator control unit (ACU) or processor 252 connected to the actuators.

The FCC 100 stores and executes an embedded real time operating system (RTOS), such as Integrity-178B by Green Hills Software Inc. The RTOS 304 handles memory access by the CPU 120, resource availability. 1/O access, and partitioning of the embedded software components (CSCs) of the computer by allocating at least one virtual address space to each CSC.

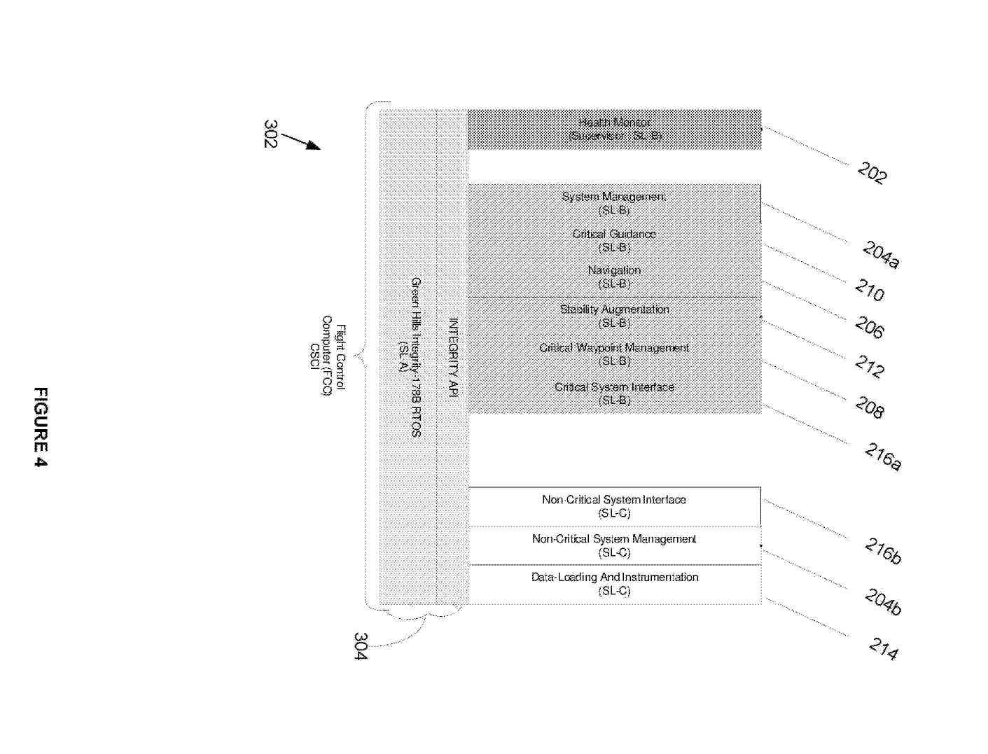

The FCC 100 includes a computer system configuration item (CSCI) 302, as shown in FIG. 4, comprising the computer software components (CSCs) and the operating system 304 on which the components run. The CSCs are stored on the flash memory 160 and may comprise embedded C++ or C computer program code. The CSCs include the following components:
(a) Health Monitor 202;
(b) System Management 204 (flight critical and non-flight critical);
(c) Navigation 206;
(d) Waypoint Management 208;
(e) Guidance 210;
(f) Stability Augmentation 212;
(g) Data Loading/Instrumentation 214: and
(h) System Interface 216 (flight critical and non-flight critical).

The Health Monitor CSC 202 is connected to each of the components comprising the CSCI 302 so that the components can send messages to the Health Monitor 202 when they successfully complete processing.

The System Interface CSC 216 provides low level hardware interfacing and abstracts data into a format useable by the other CSC's.

The Navigation CSC 206 uses a combination of IMU data and GPS data and continuously calculates the aircraft's current position (latitude/longitude/height), velocity, acceleration and attitude. The Navigation CSC also tracks IMU bias errors and detects and isolates IMU and GPS errors. The data generated by the Navigation CSC represents WGS-84 (round earth) coordinates.

Whilst the FCC 100 can rely entirely upon the navigation solution provided by the ASN system 20, the navigation CSC 206 can be used, as desired, to validate the navigation data generated by the ASN 20.

The Waypoint Management (WPM) CSC 208 is primarily responsible within the FCC for generating a set of 4 waypoints to send to the Guidance CSC 210 that determine the intended path of the vehicle through 3D space. The WPM CSC 208 also
(a) Supplies event or status data to the System Management CSC 204 to indicate the occurrence of certain situations associated with the vehicle.
(b) Checks the validity of received flight or mission plans
(c) Manages interactions with an airborne Mission System (MS) 254 of the vehicle. The MS sends route requests to the WPM 208 based the waypoints and the current active mission plan.

The Guidance CSC 210 generates vehicle attitude demand data (representing roll, pitch and yaw rates) to follow a defined three dimensional path specified by the four waypoints. The attitude rate demands are provided to the Stability Augmentation CSC 212. The four waypoints used to generate these demands are received from the Waypoint Management CSC 208. The Guidance CSC 210 autonomously guides the vehicle in all phases of movement.

The Stability Augmentation (SA) CSC 212 converts vehicle angular rate demands into control surface demands and allows any manual rate demands that may be received by the GVC to control the vehicle during ground operations when necessary. The SA CSC 212 also consolidates and converts air data sensor readings into air speed and pressure altitude for the rest of the components.

The Infrastructure CSC is a common software component used across a number of the CSCs. It handles functions, such as message generation and decoding, 10 layer interfacing, time management functions, and serial communications and protocols such UDP.

The System Management CSC 204 is responsible for managing a number of functions of the FCC, including internal and external communications, and establishing and executing a state machine of the FCC CSCI 302 that establishes one or a number of states for each of the phases of movement of the vehicle. The states each correspond to a specific contained operation of the vehicle and transitions between states are managed carefully to avoid damage or crashing of the vehicle. The state machine controls operation of the CSCI together with the operations that it instructs the vehicle to perform. The states and their corresponding phases are described below in Table 1.

TABLE 1

| Flight Phase | States | Description |
|---|---|---|
| Start-Up | COMMENCE | Initial state, performs continuous built in testing |
| | | (CBIT) checking. |
| | NAV_ALIGN | Calculates initial heading, initialises Navigation |
| | | 206. |
| | ETEST | A state where systems testing may be |
| | | performed. |
| | START_ENGINE | Starting of the engine is effected. |
| Taxi | TAXI | Manoeuvre vehicle to takeoff position. |
| Takeoff | TAKEOFF | The vehicle is permitted to takeoff and |
| | | commence flight. |
| | CLIMBOUT | The vehicle establishes a stable speed and climb |
| | | angle |
| Climb out, | SCENARIO | The vehicle follows waypoints generated based |
| Cruise | | on a scenario portion of a flight or mission plan. |
| | LOITER | Holding pattern where a left or right hand circle |
| | | is flown. |
| Descent | INBOUND | Head to the landing site (e.g. runway and |
| | | airfield). |
| Landing | CIRCUIT | Holding in a circuit pattern around the airfield. |
| | APPROACH | In a glide slope approaching the runway. |
| | LANDING | Flaring, and touching down on the runway. |
| Rollout | ROLLOUT | Confirmed as grounded, and deceleration of the |
| | | vehicle tracking the runway centreline. |
| | TAXI | Take the vehicle to shutdown position. |
| Shutdown | ENGINE_SHUTDOWN | Termination of engine operations. |
| | SHUTDOWN | Termination of the FCC. |

The System Management Component 204 determines the existing state and effects the changes between the states based on conditions for applicable transitions for each state, and based on data provided by the CSCs, such as Guidance, Navigation and Stability Augmentation and Waypoint Management which depend on the current state, and represent the current status of the vehicle. The status data provided by the CSCs affecting the states is in turn dependent on the sensor data received by the FCC 100.

### Landing System Process

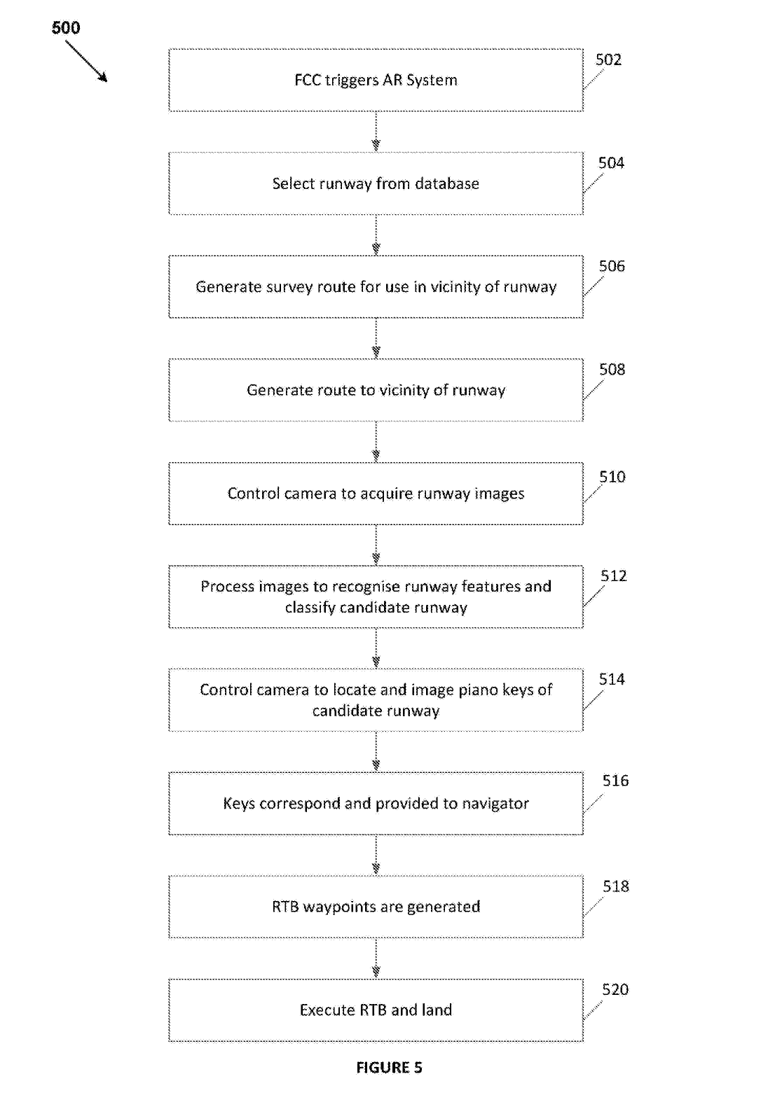

The autonomous recovery process 500, as shown in FIG. 5, executed by the landing system 10 includes:
1) The AR system 50, 60, 70 is triggered (step 502) by the FCC 100. This can be because the FCC 100 determines that the state of the vehicle is unfit for its intended purpose, or remotely via an operator command.
2) The closest airfield is selected (504) from a runway database, taking into account current wind conditions.
3) A runway survey route is generated (506) based on runway feature data of the selected airfield in the runway database. The survey route is used to fly the vehicle on a route that gives the vehicle a strong likelihood of being able to locate the desired runway. Once the vehicle is in the runway vicinity. The survey route takes into account any no-fly areas enforced during the mission.
4) A route is generated (508) to take the vehicle from its current position to the vicinity of the airfield. This mute takes into account any no-fly areas enforced during the mission.
5) In the vicinity of the airfield, the gimbaled camera 34 is controlled so as to detect and image the likely runway candidate whilst the vehicle flies the survey route (510).
6) Images of the runway candidate are scanned for key runway features, and classified as being of the candidate runway if it has the required features (512).
7) The camera is controlled to locate the corners of the runway piano keys (514). The piano keys are geo-located using a tracking process of a tracker implemented with an unscented Kalman filter.
8) If the tracked runway has features corresponding to the features for the runway in the runway database, the runway track, which can comprise four constrained corner points, is transformed into a set of runway coordinates (centre position, length, width and heading) and inserted into the ASN 20 as a Simultaneous Localisation and Mapping (SLAM) feature set to provide a coupled navigation-tracking solution (516).
9) A return-to-base (RTB) waypoint set is generated (518) to enable the aircraft to perform inbound, circuit, approach, and landing. The RTB set takes into account any no-fly areas enforced during the mission, as well as the prevailing wind conditions, to determine the landing direction.
10) The aircraft executes the RTB (520) and augments its height during landing using the height sensor and its lateral track the runway edge data obtained into the runway track that has been fused or coupled into the navigation filter as runway navigation coordinates. The landing waypoints are dynamically updated to null cross-track errors relative to the estimated runway centerline.

The autonomous recovery process 500 executes a passive landing process for the vehicle that creates a map of features that have been detected in the images, and couples navigation with tracking to give a robust method for landing even on objects that are moving.

Removal of any independence of feature detection/tracking and the navigation loop is significant. It is the ability to directly couple these processes together that enables highly accurate relative positioning without the need for ground augmentation systems. The system 10 has the ability to (i) distinguish the target landing area, and (ii) detect features from the target landing area for relative positioning. By using an image processing system that provides information about the landing area (in the camera frame, and by knowledge of camera calibration, and the aircraft body frame), the system 10 is able to derive key relative information about the landing area. For generality, the landing area can be modeled as a 6-DOF object (3 components of position/velocity, 3 components of attitude) with landing site data for verification purposes such as the geometry of the landing area. In the case of an airfield, the runway has particular features that can be used to establish a runway track with high confidence (threshold markings, landing markings, touch down markings, runway centerline). As described below, because of the static nature of an airfield runway, the track states can be transformed into six navigation coordinate states being 3 positions, runway direction, and length and width. In the case of a helipad on a ship deck, there are similar features on the ship deck, such as helipad markings, that allow for the landing area to be detected and tracked. The primary difference between a ship deck and an airfield is the additional dynamic states and prediction used in the navigation/tracking processes. For example, the monitored states of the landing site are 3 positions, 3 velocities, 3 attitudes, 3 attitude rates, and helipad or landing deck geometry. The fact that the landing area is attached to a ship (with characteristic motion) is used to constrain the predictive element of the navigation/tracking processes. Because the tracking and navigation processes are coupled together, the resulting relative positioning algorithms are extremely robust to navigation errors or even faults in aiding sources such as GPS multipath interference, as described below.

### Runway Database

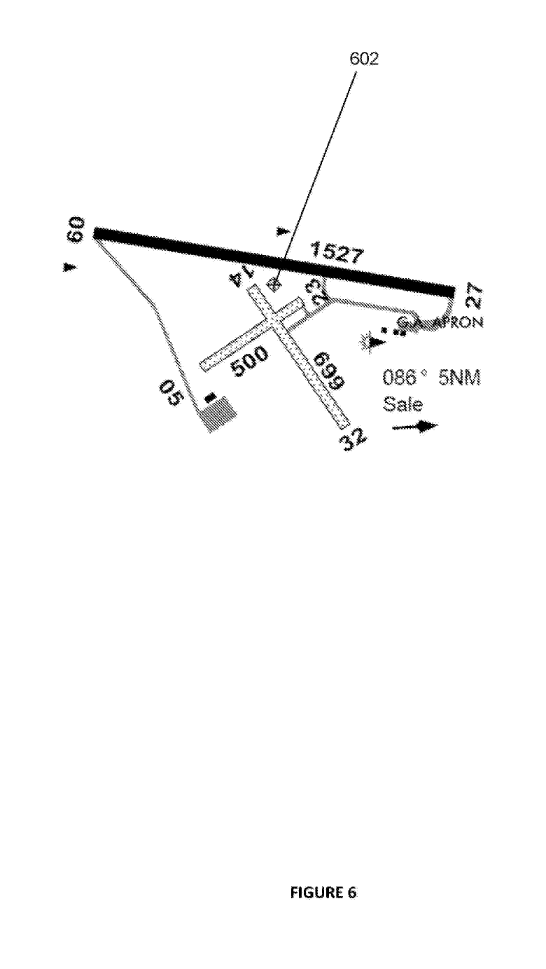

The AR system 50, 60, 70 stores a database of runway and airfield data similar to that provided by Jeppesen NavData™ Services, and provides runway characteristics or feature data on runways of airfields. In one embodiment the En-Route Supplement Australia (ERSA) data (see Joo, S., Ippolito, C., Al-Ali, K., and Yeh, Y.-H., Vision aided inertial navigation with measurement delay for fixed-wing unmanned aerial vehicle landing. Proceedings of the 2008 IEEE Aerospace Conference, March 2008, pp. 1-9.) has been used, and this provides data about all airfields in Australia. An example of the key airfield data provided from ERSA is provided below in Table 2 and shown in FIG. 6.

TABLE 2
WEST SALE

| | |
|---|---|
| AVFAX CODE 3059 | ELEV 93 |

| VIC | | UTC + 10 | YWSL |
|---|---|---|---|
| S 38 05.5 | E 146 57.9 | VAR 12 DEG E | REG |

AD OPR Wellington Shire Council, PO Box 506, Sale, VIC, 3850. Ph 03 5142 3333, FAX
5142 3499, ARO 5149 2337; 0407 835 419.
HANDLING SERVICES AND FACILITIES
Aero Refuellers 24 HR JET A1. AVGS by tanker daylight HR only. Limited service
weekends. Phone 0458 411 599.
PASSENGER FACILITIES
PT/TX/LG/WC
SURFACE MOVEMENT GUIDANCE
Fixed distance & touchdown markings no AVBL.
METEOROLOGICAL INFORMATION PROVIDED

| | |
|---|---|
| 1. | TAF CAT D. |
| 2. | East Sale AWIS - 125.4 or Phone 03 5146 7226 |

PHYSICAL CHARACTERISTICS

| | | | | |
|---|---|---|---|---|
| 05/23 | 044 | 16c | Grassed grey silt clay. | WD 30 RWS 90 |
| 09/27 | 087 | 50a | PCN 12/F/B/600 (87 PSI)/T | WID 30 RWS 150 |
| 14/32 | 133 | 23c | Grassed grey slit clay. | WID 30 RWS 90 |

The important information required by the AR process is: location of the airfield reference point 602 (latitude=−38,05.5, longitude=146.57.9), height above mean sea-level (93 feet), magnetic field offset (+12 deg), number of runways (3), runway surface characteristics (2 grass, 1 bitumen), runway lengths (1527, 699, 500 m) and width (30 m), and runway magnetic heading (44, 87, and 133 deg). The airfield reference point 602 gives the approximate location of the airfield to the nearest tenth of a minute in latitude and longitude (±0.0083 deg). This equates to an accuracy of approximately 100 m horizontally. Furthermore, the reference point in general does not lie on any of the runways and cannot be used by itself to land the aircraft. It is suitable as a reference point for pilots to obtain a visual of the airfield and land. The landing system 10 performs a similar airfield and runway recognition and plans a landing/approach path.

For the UAV to identify and perform an autonomous landing on the desired runway, an accurate navigation solution is used. In low-cost UAVs, a GPS-aided Inertial Navigation System (INS) system is used. Yet. GPS is heavily relied upon due to the poor performance of low-cost inertial measurement units. GPS has very good long term stability, but can drift in the short term due to variations in satellite constellation and ionospheric delays. The amount of drift is variable, but could be on the order of 20 m. This is one of the main reasons why differential GPS is used for automatic landing of UAVs. Differential GPS allows accuracies of the navigation solution on the order of approximately 1-2 m. The autonomous recovery (AR) system is assumed to have and CAN operate with no differential GPS available, but may use at least one functional GPS antenna. A GPS antenna is not required if the Simultaneous Localisation and Mapping (SLAM) capability of the All-Source Navigation system 20 is used, as described in the ASN paper.

The AR system 50, 60, 70 uses image processing to extract information about a candidate airfield. Virtually all UAVs are equipped with gimbaled cameras as part of their mission system, and in an emergency situation, the camera system can be re-tasked to enable a safe landing of the UAV. Other sensors such as LIDAR, although very useful for helping to characterize the runway, cannot always be assumed to be available. Additional sensors are not required to be installed on the UAV to enable the autonomous recovery system 50, 60, 70 to work. Only image processing is used, and electro-optical (EO) sensing is used during daylight hours and other imaging, such as infrared (IR) imaging is used in identifying the runway during night operations.

### Airfield Selection

When the AR process is triggered (502), the current vehicle state and wind estimate are obtained from the FCC 100. The latitude and longitude of the vehicle is used to initiate a search of the runway database to locate potential or candidate landing sites. The distances to the nearest airfields are computed by the ARC 50 using the distance on the great circle. The vehicle airspeed and wind estimate are used to estimate the time of flight to each airfield assuming a principally direct flight path. The shortest flight time is used by the ARC 50 to select the destination or candidate airfield. In practice, the closet airfield tends to be selected, but accounting for the prevailing wind conditions allows the AR system to optimize the UAV's recovery.

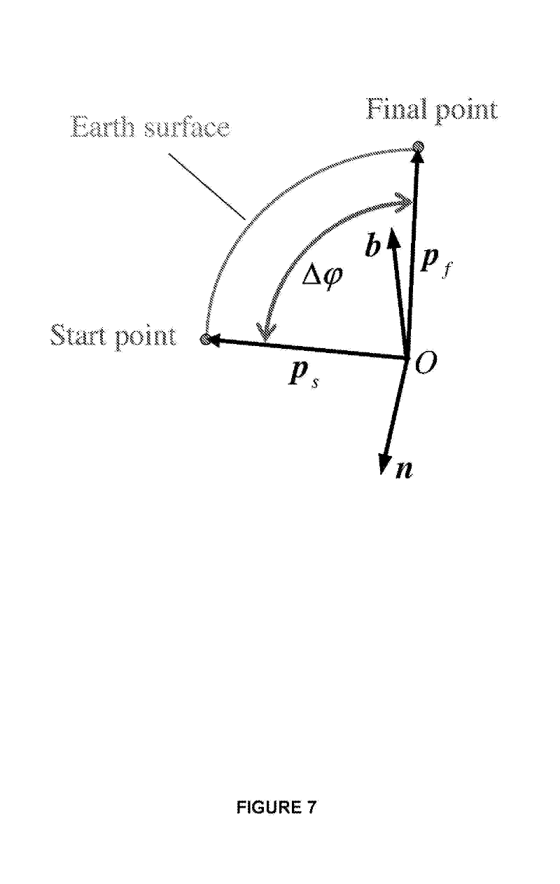

FIG. 7 shows the geometry of the problem of finding the time of flight using the great-circle. The starting position is denoted as pₛ in Earth-Centered-Earth-Fixcd (ECEF) coordinates. The final position is denoted as p_{f}, also in ECEF coordinates. The enclosing angle is given by

$$Δ ϕ = {tan}^{- 1} ( \frac{‖ {p}_{f} \times {p}_{x} ‖}{{p}_{f} \cdot {p}_{x}} ) \qquad ( 1 )$$

A coordinate frame with an x-axis is aligned with the direction of pₛ, so a normal vector is given by n=pₛ×p_{f}/∥p_{f}×pₛ∥, and a bi-normal vector given by b=n×pₛ/∥pₛ∥. The time of flight is computed using a discrete integration approximation as follows:

$$\begin{matrix}t = {\sum }_{i = 0}^{N} Δ {t}_{i} & ( 2 ) \\ Δ {t}_{i} = \frac{{R}_{e} i \frac{Δ ϕ}{N}}{{v}_{{g}_{i}}} & ( 3 ) \\ {v}_{{g}_{i}} = {v}_{tas} + {C}_{n}^{e} {w}_{i} \cdot ( \frac{{p}_{i} - {p}_{i - 1}}{‖ {p}_{i} - {p}_{i - 1} ‖} ) & ( 4 ) \\ {p}_{i} = {C}_{x}^{i} ( i Δ ϕ \text{/} N ] {p}_{x} & ( 5 )\end{matrix}$$

where wᵢ is the local estimated wind vector in the navigation frame. The term Cₛⁱ[iΔφ/N] represents a planar rotation matrix in the pₛ˜b plane that effectively rotates the vector pₛ to pᵢ. The rotation is around the +n-axis. For short distances, the above may be simplified by computing the time of flight using in a local North-East-Down (NED) frame and ignoring the effect of spherical geometry.

When selecting potential airfields, the type of runway and runway lengths is also taken into account. For example, one embodiment of the AR system 50, 60, 70 requires a runway with standard runway markings, i.e., a bitumen runway, so the runway can be positively confirmed by the AR system as being a runway. The minimum landing distance required by the aircraft is also used to isolate runways that are not useable. Once an airfield is selected, the ERSA data is converted into a runway feature data format to be further used by the AR system. This includes conversion of the airfield reference height to the WGS84 standard using EGM96 (Earth Gravitational Model 1996) (see Lemoine, F. G., Kenyon, S. C., Factor, J. K., Trimmer, R. G., Pavlis, N. K., Chinn, D. S., Cox, C. M., Klosko, S. M., Luthckc, S. B., Torrence, M. H., Wang. Y. M., Williamson, R. G., Pavlis. E. C., Rapp. R. H., and Olson, T. R., The Development of the Joint NASA GSFC and NIMA Geopotential Model EGM96, NASA/TP-1998-206861), and conversion of the runway heading from magnetic to true.

### Generation of Survey Route

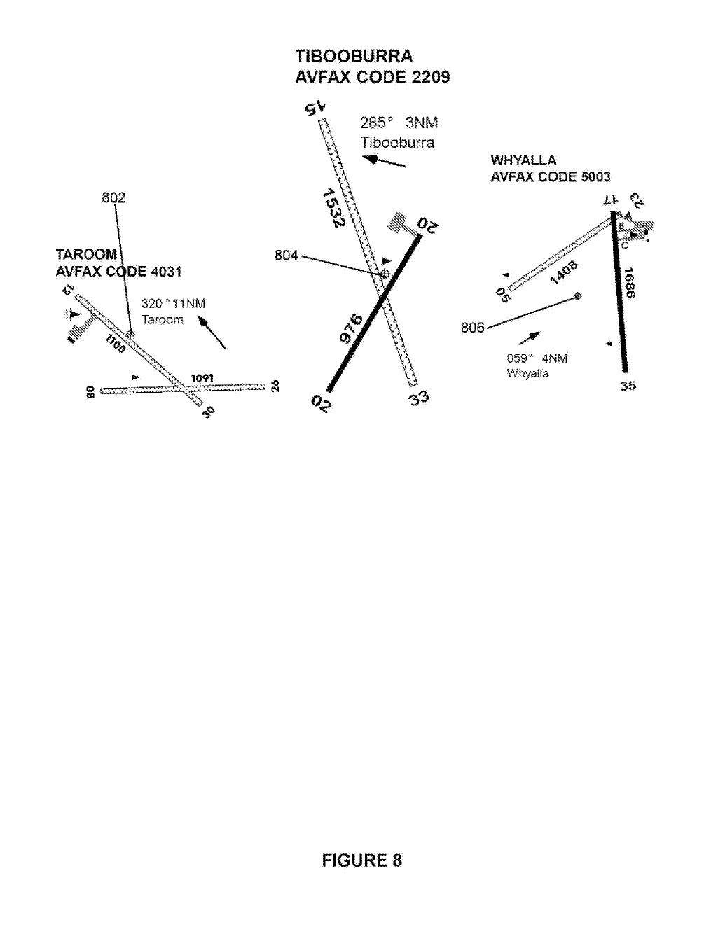

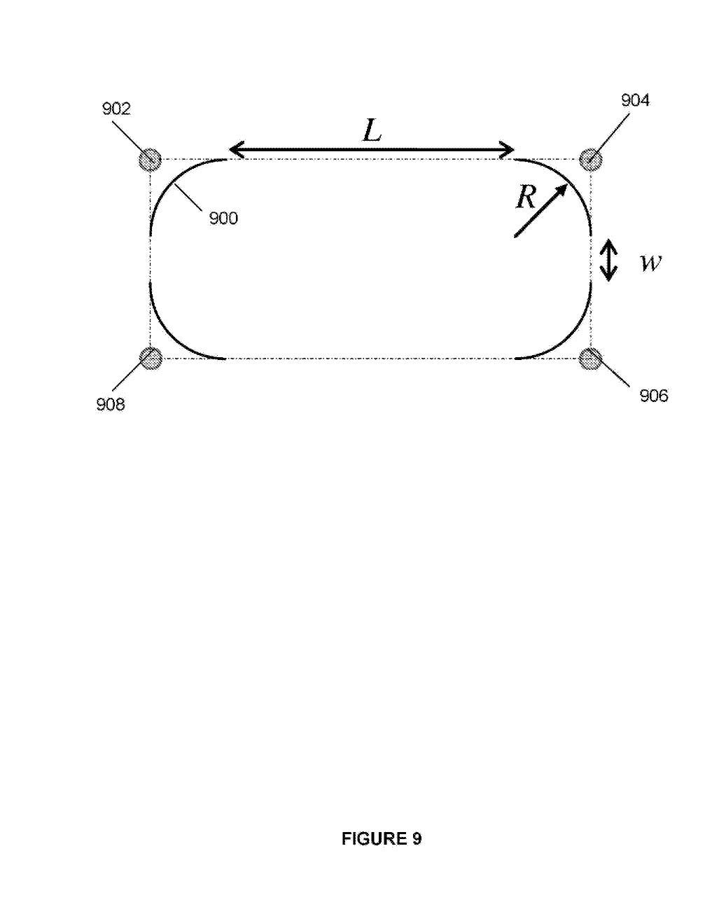

The survey route is generated and used to provide the UAV with the maximum opportunity to identify and classify the candidate runway. The system 10 also needs to deal with no-fly areas around the target runway when determining and flying the survey route. The APG system 60 executes a survey route generation process that iterates until it generates a suitable survey route. The data used by the APG 60 includes the ERSA reference point, runway length, and runway heading. Maximum opportunity is afforded by flying the vehicle parallel to the ERSA runway heading (which is given to ±1 deg). The desired survey route is a rectangular shaped flight path with side legs approximately 3 runway lengths L long, as shown in FIG. 9. The width W of the rectangle is dictated by the turn radius R of the flight vehicle. The center of the survey route is specified as the ERSA reference point. This point is guaranteed to be on the airfield, but is not guaranteed to lie on a runway. For example, FIG. 8 shows three different airfields and their respective reference points 802, 804 and 806.

If there are no no-fly zones around the airfield, then the survey mute generation process is completely quickly, but generally iteration is required to select the combination of survey route center point, side length, width, and rotation that fits within the available flight area. The survey route 900 consists of 4 waypoints 902, 904, 906 and 908, as shown in FIG. 9. The waypoints are defined relative to the center of the rectangle in an NED coordinate frame. The side length L varies from 0 to Lₘₐₓ, and the width w varies from 0 to wₘₐₓ. In the worst case, the side length and width are zero, giving a circular flight path with minimum turn radius R.

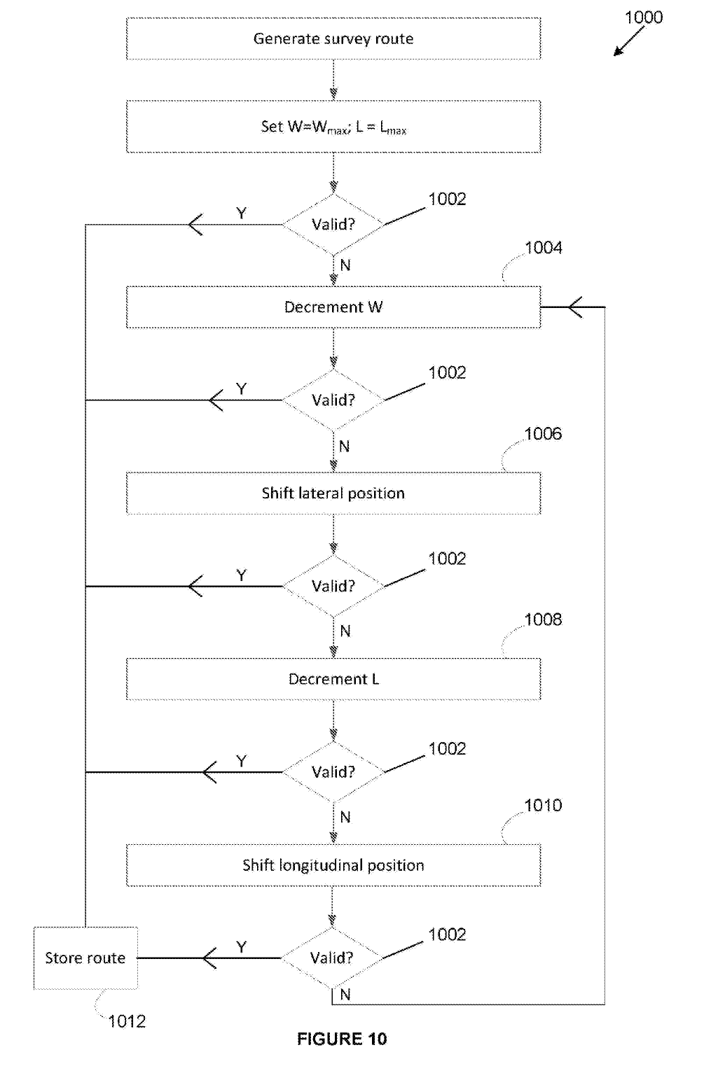

An iterative survey route generation process 1000, as shown in FIG. 10, is used to determine the survey route is as follows:
1) While a valid survey route solution does not exist (i.e., path does not yet lie completely within flyable regions), do the following:
   (a) Vary w from wₘₐₓ to 0, where wₘₐₓ is equal to the runway length (1004).
   (b) Vary the lateral position of the center of the route (perpendicular to runway direction) in step 1006.
   (c) Vary L from Lₘₐₓ to 0, where Lₘₐₓ is three times the runway length (1008).
   (d) Vary the longitudinal position of the center of the survey route (parallel to runway direction) in step 1010.
2) When a valid survey route is found (1002), the waypoints are stored (1012) together with the center of the route for later use.

### Route to Airfield

The aircraft needs to be routed from its current position and heading, to the generated survey route. The route to the airfield must take into account any no-fly regions, such as those that may be active during a mission. The route to the airfield is constructed by the APG system 60 using the route generation process discussed in the Routing paper. The initial position and velocity are taken from the ASN system 20, and the destination point used is the center of the generated survey mute. To ensure that the route is able to be generated to the desired destination, a new node is inserted into the route generation process. The route to the destination is then constructed.

In practice, it is sometimes possible that a route cannot be constructed due to the UAV's proximity to flight extents at the time the AR process 500 is initiated. The ARC 50 of the AR system monitors the route generation process and if no valid route is returned, it restarts the process. The AR system will attempt to route the vehicle to the destination point until it is successful.

When a route to the airfield is successfully generated, a transfer route is also generated by the APG 60 that connects the mute to the airfield and the runway survey mute. This process is also iterative, and attempts to connect to a point along each edge of the survey route, and begins with the last waypoint on the airfield route.

Once the mutes are all generated they are provided by the ARC 50 to the WPM 208 of the FCC 100 to fly the aircraft to the airfield and follow the survey mute.

### Airfield Detection and Tracking

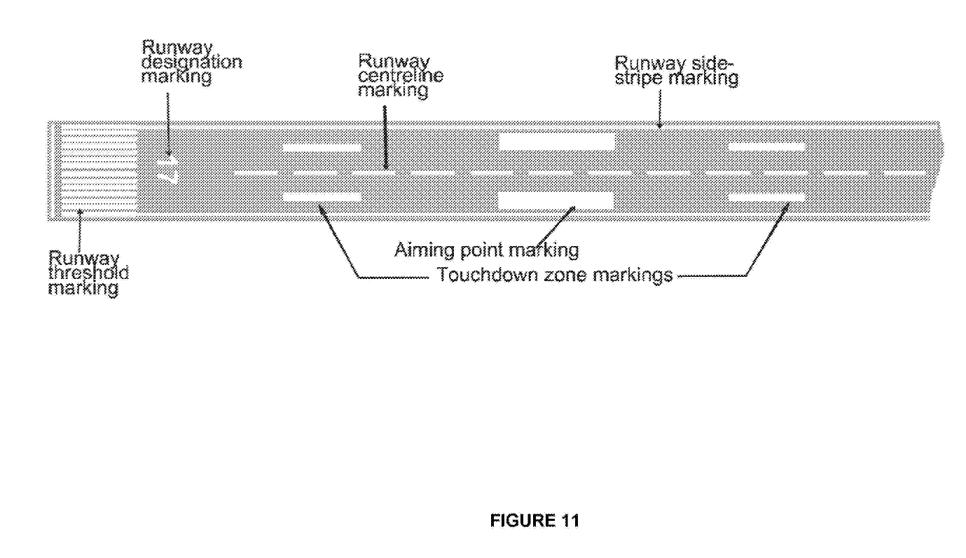

Once the aircraft is following the survey route, the GEO system 30 commands the turret 32 to point the camera 34 so as to achieve a particular sequence of events. In the first phase, the camera 34 is commanded to a wide field-of-view (FOV), with the camera pointed towards the airfield reference point. In this phase, the FDC 70 attempts to locate the most likely feature in the image to be the candidate runway. The runway edges are projected into a local navigation frame used by the ASN 20. The approximate edges of the runway are then used to provide an estimate of the runway centreline. The camera 34 is slewed to move along the estimated centreline. The FDC 70 analyses the imagery in an attempt to verify that the edges detected in the wide FOV images in fact correspond to a runway. This is done by looking for key features that are present on runways, such as runway threshold markings (piano keys), runway designation markings, touchdown zone markings, and aiming point markings. These markings are standard on runways, as shown in FIG. 11. By using all of these features, the FDC 70 is able to confirm an actual specific runway, flight deck or helipad is within view of the aircraft, as opposed to simply confirming a possible site to land.

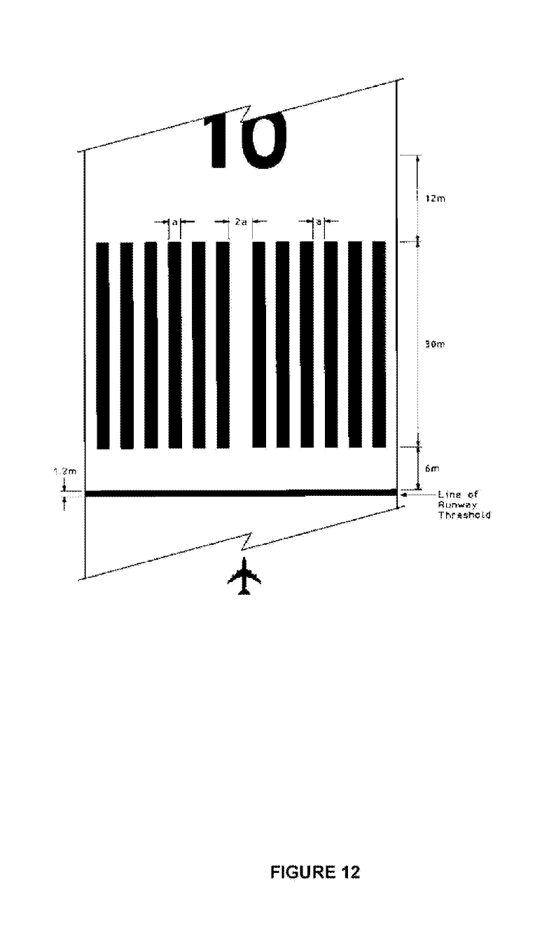

Once the runway is confirmed to be the desired runway, the FDC 70 alternately points the turret 32 towards the threshold markings at each end of the runway. This is designed to detect the correct number of markings for the specific runway-width. The layout of the piano keys is standard and is function of runway width, as shown in FIG. 12 and explained in Table 3 below. The corners of the threshold markings shown in FIG. 12 are detected as pixel coordinates and are converted into bearinglelevation measurements for the corners before being passed from the FDC 70 to the ARC 50.

The corners of the threshold markings are not the corners of the actual runway, so the edge is offset by an amount given by d=w/2−Na, where N is the number of piano keys, w is the runway width, and a is the width of the piano keys, as shown in Table 3. This is used to compare the estimated width of the runway based on the piano keys, and the ERSA width in the runway database. It is also used in runway edge fusion, described later.

TABLE 3

| Runway Width | | Width of Stripe Space (a) |
|---|---|---|
| metres | Number of Stripes | metres |
| 15.18 | 4 | 1.5 |
| 23 | 6 | 1.5 |
| 30 | 8 | 1.5 |
| 45 | 12 | 1.7 |
| 80 | 16 | 1.7 |

The FDC 70 computes the pixel coordinates of the piano keys in the image plane. The pixel coordinates are corrected for lens distortion and converted into an equivalent set of bearing φ and elevation φ measurements in the camera sensor frame.

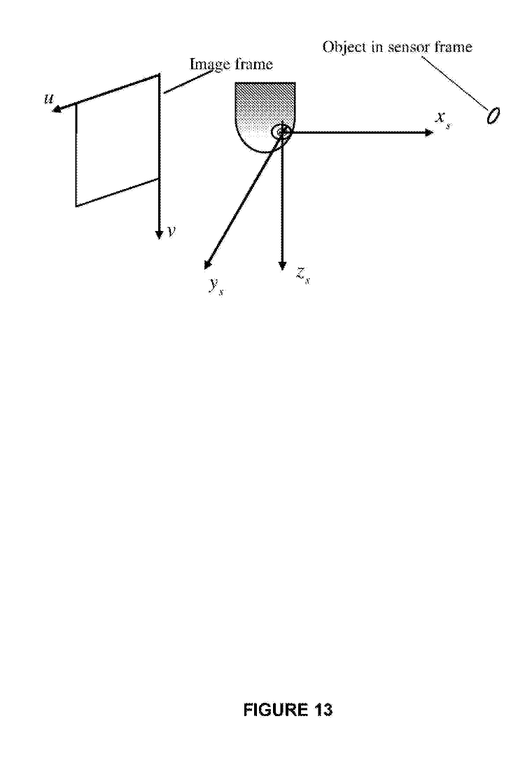

A pinhole camera model is assumed which relates measurements in the sensor frame to the image frame (u,v), as shown in FIG. 13,

$$u = \frac{1}{{f}_{u}} ( {y}_{x} \text{/} {x}_{x} ) + {u}_{0} , \\ v = \frac{1}{{f}_{v}} ( {z}_{s} \text{/} {x}_{s} ) + {v}_{0} \qquad ( 6 )$$

where fᵤ and fᵥ are the camera focal lengths, and u₀ and v₀ are pixel coordinate data.

The bearing and elevation measurements are derived from the pixel information according to

φ=tan⁻¹[u−u₀/fᵤ] (7)

φ=tan −1[v−v₀ cos φ/fᵥ] (8)

Distortion effects are also accounted for before using the raw pixel coordinates. The uncertainty of a measurement is specified in the image plane, and must be converted into an equivalent uncertainty in bearing/elevation. The uncertainty in bearing/elevation takes into account the fact that the intrinsic camera parameters involved in the computation given in Eqs. (7) and (8) are not known precisely. The uncertainty is computed via

$${σ}_{BE} = ( \frac{\partial y}{\partial x} ) {{σ}_{x} ( \frac{\partial y}{\partial x} )}^{y} + ( \frac{\partial y}{\partial p} ) {{σ}_{p} ( \frac{\partial y}{\partial p} )}^{T} \qquad ( 9 )$$

where p=[fᵤ, fᵥ, u₀, v₀]^{T}, y=[φ, φ]^{T}, x=[u,v]^{T}, σₓ is the uncertainty in the pixel plane coordinates, and σₚ is the uncertainty in the camera parameters.

### Runway Track Initialization

Once the FDC 70 detects runway corners, the ARC 50 converts the bearing/elevation measurements into a representation of the candidate runway that can be used for landing. The gimbaled camera system 30 does not provide a range with the data captured, and a bearing/elevation only tracker is used by the ARC 50 to properly determine the position of the runway in the navigation frame used by the ASN 20.

The runway track initialization is performed by the AR system independent of and without direct coupling to the ASN 20 as false measurements or false tracks can corrupt the ASN 20 which could be detrimental to the success of the landing system 10. Instead, enough confidence is gained in the runway track before it is directly coupled to the ASN 20. An unscented Kalman filter (UKF) is used to gain that confidence and handle the nonlinearities and constraints present in the geometry of the landing site.

### Tracking State

One tracking approach is to use the four corners provided by the FDC 70 as independent points in the navigation frame. The points could be initialized for tracking using a range-parameterized bank of Extended Kalman filters (EKF's) as discussed in Peech. N., Bearings-only tracking using a set of range-parameterized extended Kalman filters. IEEE Proc. Control Theory Appl., Vol. 142, No. 1, pp. 73-80, 1995, or using a single inverse depth filter as discussed in Civera. J., Davison, A. J., and Montiel, J. M. M., Inverse depth parameterization for monocular SLAM. IEEE Transactions on Robotics, Vol. 24, No. 5, pp. 932-945, 2008. The problem with using independent points is that it does not account for the correlation of errors inherent in the tracking process, nor any geometric constraints present. The tracking filter should also account for the fact that the geometry of the four corner points provided by the FDC 70 represents a runway. One option is to represent the runway using the minimal number of coordinates (i.e., runway center, length, width, and heading), however a difficulty with treating the runway as a runway initially is that all four points are not or may not be visible in one image frame. This makes it difficult to be able to initialize tracking of a finite shaped object with measurements of only one or two corners.

The ARC 50 addresses the limitations stated above, by using a combined strategy. The FDC 70 does not provide single corner points, and operates to detect a full set of piano keys in an image. Accordingly for each image update, two points are obtained. The errors in these two measurements are correlated by virtue of the fact that the navigation/timing errors are identical. This fact is exploited in the representation of the state of the runway. Each corner point is initialized using an unscented Kalman filter using an inverse depth representation of the state. The inverse depth representation uses six states to represent a 3D point in space. The states are the camera position (three coordinates) at the first measurement, the bearing and elevation at first measurement, and the inverse depth at the first measurement. These six states allow the position of the corner to be computed in the navigation frame. An optimization can be used as two corner points are always provided and hence, only one camera position is required for each end of the runway. Thus, the ARC 50 represents the runway using a total of 18 states (two camera positions each represented by coordinates x, y, z, and 4 sets of inverse depth (i/d), bearing, and elevation) for the four corners of the runway.

Tracking is performed in the ECEF frame, which as discussed below is also the navigation frame. The camera positions used in the state vector are the position in the ECEF frame at the first measurements. The bearing and elevation are the measurements made in the sensor frame of the camera 34 at first observation, rather than an equivalent bearing and elevation in the ECEF or local NED frame. The reason for maintaining the bearing/elevation in the measurement frame of the camera 34 is to avoid singularities in any later computations which can arise if bearing/elevation is transformed to a frame other than the one used to make the measurement.

The advantage of the state representation of the candidate runway is that it allows each end of the runway to be initialized independently. Geometric constraints are also exploited by enforcing a set of constraints on the geometry after each runway end has been initialized. Each end of the runway is therefore concatenated into a single state vector rather than two separate state vectors, and a constraint fusion process is performed as discussed below.

### Coordinate Frames

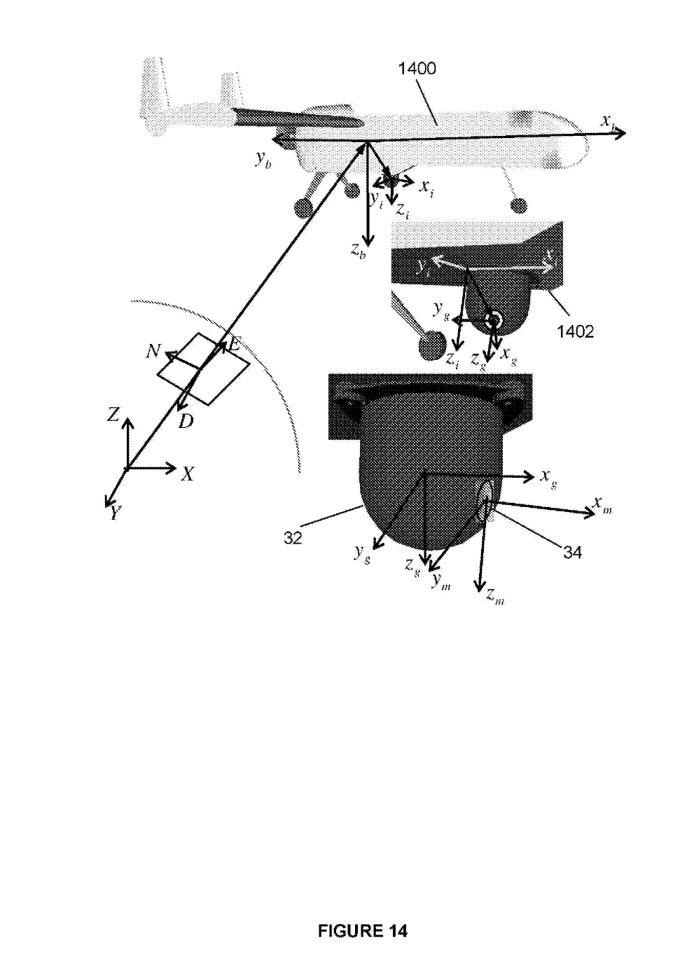

In order to compute the camera position in the ECEF frame, the AR systems 50, 60, 70 use the coordinate frames shown in FIG. 14. The Earth-Centered-Earth-Fixed (ECEF) frame (X,Y,Z) is the reference frame used for navigation of the aircraft. The local navigation frame (N,E,D) is an intermediate frame used for the definition of platform Euler angles. The NED frame has its origin on the WGS84 ellipsoid. The IMU/body frame (x_{b}, y_{b}, x_{b}) is aligned with axis of the body of the vehicle 1400 and has its origin at the IMU 190. The installation frame (xᵢ, yᵢ, zᵢ) has its origin at a fixed point on the camera mount. This allows some of the camera extrinsics to be calibrated independently of the mounting on the airframe 1402. The gimbal frame (x_{g},y_{g},z_{g}) has its origin at the center of the gimbal axes of the turret 32. Finally, the measurement frame (xₘ, yₘ, xₘ) has its origin at the focal point of the camera 34.

The position of the camera in the ECEF frame is given by

pₘ^{e}=p_{b}^{c}+Cₙ^{e}C_{b}ⁿ(pᵢ^{b}+Cᵢ^{b}(p_{g}ⁱ+C_{g}ⁱpₘ^{g})) (10)

where p_{b}^{e} is the position of the aircraft IMU 190 in the ECEF frame. Cₙ^{e} is the direction cosine matrix representing the rotation from the NED frame to the ECEF frame, C_{b}ⁿ is the direction cosine matrix representing the rotation from the body to the NED frame, pᵢ^{b} is the position of the installation origin in the body frame, Cᵢ^{b} is the direction cosine matrix representing the rotation from the installation from to the body frame, p_{g}ⁱ is the position of the gimbal origin in the installation frame, C_{g}ⁱ is the direction cosine matrix representing the rotation from the gimbal frame to the installation frame, and pₘ^{g} is the origin of the measurement frame in the gimbal frame.

The direction cosine matrix representing the rotation from the measurement frame to the ECEF frame is given by

Cₘ^{e}=Cₙ^{e}C_{b}ⁿCᵢ^{b}C_{g}ⁱCₘ^{g} (11)

where Cₘ^{g} is the direction cosine matrix representing the rotation from the measurement frame to the gimbal frame.

### First Observation

The FDC 70 provides measurement data associated with a set of corner IDs. As mentioned previously, each end of the candidate runway is initialized with measurements of the two extreme piano key corners for that end. The unit line of sight for feature k in the measurement frame is given by

$${l}_{k}^{m} = [ \begin{matrix}cos {ϕ}_{k} cos {ϑ}_{k} \\ sin {ϕ}_{k} cos {ϑ}_{k} \\ - sin {ϑ}_{k}\end{matrix} ] \qquad ( 12 )$$

The unit line of sight of the same feature in the ECEF and NED frames are given respectively by

lₖ^{e}=Cₘ^{e}lₖ^{m} (13)

lₖⁿ=C_{c}ⁿlₖ^{e} (14)

The initial inverse depth of the feature is estimated using the ERSA height of the runway (expressed as height above WGS84 ellipsoid) and the current navigation height above ellipsoid. The inverse depth is given by

$${λ}_{k} = \frac{{l}_{k}^{n} \cdot k}{h - {h}_{ERSA}} \qquad ( 15 )$$

In equation (15), k is the unit vector along the z-axis in the NED frame (D-axis). The dot product is used to obtain the component of line of sight along the vertical axis.

The uncertainty of the inverse depth is set equivalent to the depth estimate, i.e., the corner can in theory lie anywhere between the ground plane and the aircraft. The initial covariance for the two corners is thus given by

P₀=blkdiag└Pₚ_{_{c}}_{^{k}},P_{BE}_{₁},P_{λ}_{₁},P_{BE}_{₂},P_{λ}_{₂}┘ (16)

where Pₚ_{ₖ}_{^{c}} is the uncertainty in the camera position. P_{BE}_{ₖ} is the uncertainty in the bearing and elevation measurement for feature k, and P_{λ}_{ₖ} is the uncertainty in the inverse depth for feature k, and the function blkdiag gives the block diagonal of the component matrices, i.e. blkdiag (P₁, P₂)=[P₁, 0; 0, P₂].

The position of the feature in the ECEF frame can be estimated from the state of the tracking filter of the ARC 50. The initial CR from the first measurement, it is stored and the ECEF position is given by

pₖ^{e}=p_{c}^{e}+Ĉ^{e}ₘ\hat{l}ₖ^{m} (17)

where \hat{l}ₖ^{m} is calculated using the filler estimated bearing and elevation, not the initial measured one, and p_{c}^{e} is the filter estimated initial camera position. The hearing/elevation and inverse depth of each feature are assumed to be uncorrelated when initialized. The inverse depth is in fact correlated due to the fact that the ERSA height and navigation heights are used for both corners. However, the initial uncertainty in the estimates is such that the effects of neglecting the cross-correlation is small. The error correlation is built-up by the filter during subsequent measurement updates.

For the purposes of assessing the accuracy of the corner estimates, the covariance of the filter state is translated into a physically meaningful covariance. i.e., the covariance of the corner in the ECEF frame. This can be done by using the Jacobian of Eq. (17),

$${H}_{FILTER}^{ECEF} = \frac{\partial {p}_{k}^{e}}{\partial x} \qquad ( 18 )$$

A similarity transformation is used to obtain the covariance in the ECEF frame

Pₖ^{g}=H_{FILTER}^{ECEF}P(H_{FILTER}^{ECFE})^{T} (19)

### Observation Fusion

The tracker of the ARC 50 uses an unscented Kalman filter (UKF) (as described in Julier, S. J., and Uhlmann, J. K., A new extension of the Kalman filter to nonlinear systems, Proceedings of SPIE, Vol. 3. No. 1, pp. 182-193, 1997) to perform observation fusions. The UKF allows higher order terms to be retained in the measurement update, and allows for nonlinear propagation of uncertain terms directly through the measurement equations without the need to perform tedious Jacobian computations. For the UAV 1400, more accurate tracking results were obtained compared to an EKF implementation. There is no need to perform a propagation of the covariance matrix when the runway is a static feature. Due to the random walk (variation of errors) in the navigation data provided by the ASN 20, a small amount of process noise can be added to the covariance as a function of time to prevent premature convergence of the solution. This noise is treated as additive and does not need to be propagated using the UKF.

The UKF updates the filter state and covariance for the four tracked features of the runway from the bearing and elevation measurements provided by the FDC 70. The state vector with the process and measurement noise as follows

$${x}_{k} = [ \begin{matrix}{x}_{k}^{q} \\ {w}_{k}\end{matrix} ] \qquad ( 20 )$$

where xₖ^{s} represents the filter state at discrete time k, and wₖ represents the measurement noise for the same discrete time.

The first step in the filter (as discussed in Van der Merwe. R., and Wan, E. A., The square-root unscented Kalman filter for state and parameter estimation, Proceedings of the 2001 IEEE International Conference on Acoustics, Speech, and Signal Processing, May 2001, pp. 3461-3464) is to compute the set of sigma points as follows

Xₖ₋ₜ=[\hat{x}ₖ₋₁,\hat{x}ₖ₋₁+γSₖ,\hat{x}ₖ₋₁−γSₖ] (21)

where \hat{x} is the mean estimate of the state vector, Sₖ is the Cholesky form of the covariance matrix, and the parameter γ is defined by

γ=\sqrt{L+λ} (22)

and λ=α²(L+k)−L is a scaling parameter, with the values of α and k selected appropriately, and L is the dimension of the augmented state. The sigma points are then propagated through the nonlinear measurement equations as follows

Y_{k|k-1}=h(Xₖ₋₁,tₖ) (23)

The mean observation is obtained by

$${\hat{y}}_{k}^{-} = {\sum }_{i = 0}^{2 L} {W}_{L}^{mean} {y}_{i , k \vert k - 1} \qquad ( 24 )$$

Where

$${W}_{i}^{mean} = \{ \begin{matrix}\frac{λ}{L + λ} , i = 0 \\ \frac{1}{2 L + λ} , i = 1 , … , 2 L\end{matrix} \qquad ( 25 )$$

The output Cholesky covariance is calculated using

S _{y̅}_{ₖ}=qr[\sqrt{W₁^{cov}y_{L2L,k}−ŷ _{k̅},\sqrt{Rₖ}}] (26)

S_{ŷ}_{ₖ}=cholupdate S_{ŷ}_{ₓ},y_{0,k}−ŷ _{k̅},W₀^{cov} (27)

Where

$${W}_{i}^{cov} = \{ \begin{matrix}\frac{λ}{L + λ} + 1 - {α}^{2} + β , i = 0 \\ \frac{1}{2 L + λ} , i = 1 , … , 2 L\end{matrix} \qquad ( 28 )$$

and qr{ } represents the QR decomposition of the matrix, and cholupdate{ } represents the Cholesky factor update. The cross-correlation matrix is determined from

$${P}_{{x}_{k} {y}_{k}} = {\sum }_{1 = 0}^{2 L} {W}_{i}^{cov} {X}_{i , k \vert k - 1} - {\hat{x}}_{i , k \vert k - 1} - {\hat{x}}_{k}^{-} {y}_{i , k \vert k - 1} - {\hat{y}}_{k}^{{-}^{T}} \qquad ( 29 )$$

The gain for the Kalman update equations is computed from

Kₖ=Pₓ_{ₖ}_{y}_{ₖ}/S_{ŷ}_{ₖ}^{T}/S_{ŷ}_{ₖ} (30)

The state estimate is updated with a measurement using

\hat{x}ₖ=\hat{x}ₖ+Kₖ(yₖ−ŷₖ) (31)

and the covariance is updated using

Sₖ=cholupdate{S _{k̅},KₖS_{ŷ}_{ₖ},−1} (32)

The ARC 50 accounts for angle wrapping when computing the difference between the predicted bearing/elevation and the measured ones in Eqs. (26), (27), (29), and (31).

The state is augmented by measurement noise to account for the significant errors in the back projection of the corner points into a predicted bearing and elevation for fusion. The errors that are nonlinearly propagated through the measurement prediction equations are: 1) navigation euler angles, 2) installation angles of the turret relative to the aircraft body, 3) navigation position uncertainty, and 4) the gimbal angle uncertainties. These errors augment the state with an additional 12 states, leading to an augmented state size of 30 for the tracker of the ARC 50.

### Constraint Fusion

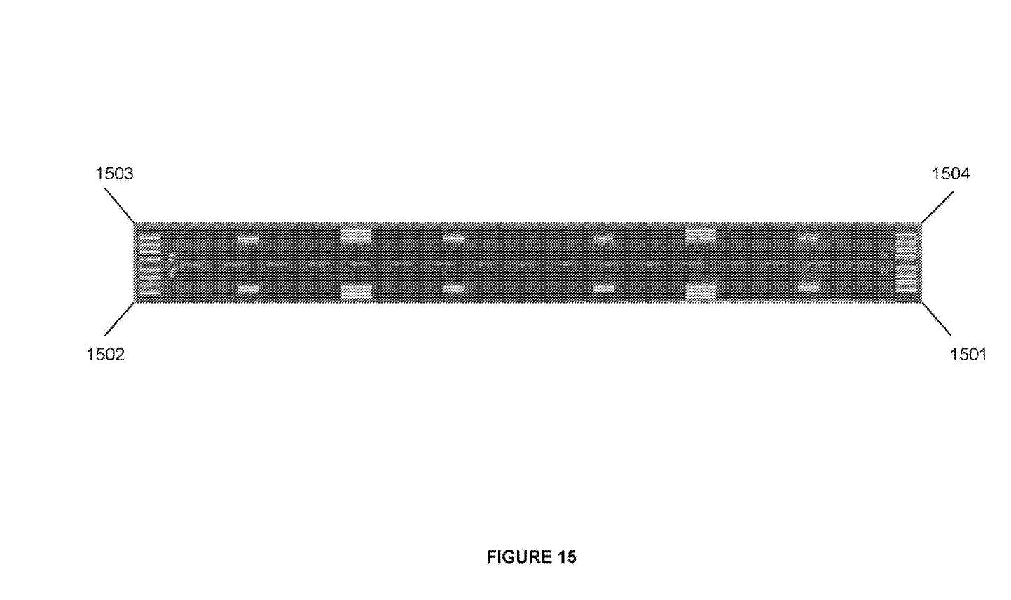

The final step of the runway initialization takes into account the geometric constraints of the candidate runway. The UKF's ability to deal with arbitrary measurement equations to perform a fusion using 6 constraints is used and the constraints are formed with reference to the runway geometry shown in FIG. 15.

The constraints that are implemented are that the vectors between corners 1501 to 1504 and 1501 to 1502 are orthogonal, 1501 to 1502 and 1502 to 1502 are orthogonal, 1503 to 1504 and 1502 to 1503 are orthogonal, and 1503 to 1504 and 1501 to 1504 are orthogonal. The runway length vectors 1501 to 1502 and 1503 to 1504, as well as the width vectors 1502 to 1503 and 1501 to 1504, should have equal lengths. The vectors are computed in the NED frame and omit the down component. Similar known geometry constraints can be employed for flight decks and helipads.

The constraint fusion is implemented with the UKF as a perfect measurement update by setting the measure covariance in the UKF to zero. The constraints are applied as pseudo-observations due to the complexity of the constraints and their relationship to the state variables (see Julier, S. J., and LaViola, J. J., On Kalman filtering with nonlinear equality constraints. IEEE Transactions on Signal Processing, Vol. 55. No. 6, pp. 2774-2784, 2007).

### Runway Initialization Validation

Once the ARC 50 establishes the runway track, i.e., all four corners have been initialized, it is compared with the known ERSA runway characteristics. The runway track produced by the tracker of the ARC 50 needs to pass a series of checks in order for the landing system 10 to allow the vehicle to land on the runway. The checks performed are:
1) Runway length edges are in agreement with each other, and within a tolerance of the ERSA runway length
2) Runway width edges are in agreement with each other, and within a tolerance of the ERSA runway width (accounting for piano key offset from the edge)
3) Runway alignment is within a tolerance of the ERSA supplied heading
4) Runway centre uncertainty is less than a tolerance in the North, East, and Down directions
5) A moving average of a number of the last absolute corner corrections is less than a tolerance for all 4 corners. For each filter update a change in the filter state, being a representation of the four corners, is computed. A projected corner position before and after a filter update is used to also generate a change of position for the corner points and this is also stored. The check is accordingly passed when the positions of the corners do not change significantly.

Once all of the checks pass, the runway track has been confirmed by the ARC 50 as a track of an actual runway that is part of the ERSA database, the track is inserted into the navigation filter provided by the ASN 20 to provide a tightly-coupled fusion with the navigation state of the aircraft.

### Coupled Navigation Runway Tracking Fusion

The runway track is inserted into the navigation filter of the ASN 20 using a minimal state representation. The 18 state filter used to initialize and update the runway track is converted into a 6 state representation with the states defined by: 1) North. East and Down position of the runway relative to the ERSA reference point, 2) Runway length, 3) Runway width, and 4) Runway heading. For a runway that is not fixed, such as a flight deck on an aircraft carrier, other states can be represented and defined by other degrees of freedom (DOF) of movement. For example, states may be defined by the roll, yaw and pitch (attitude) of the runway or the velocity and rate of change of measurements of the runway relative to the aircraft. A runway, flight deck or helipad can be represented by 3 position states (e.g. x, y, z), 3 velocities (representing the rates of change of each position state) 3 attitude states (roll, yaw and pitch), 3 attitude states (representing the rates of change of each attitude state) and states representing the geometry of the runway, flight deck or helipad.

For the confirmed runway track, subsequent corner measurements are fused directly into the navigation filter, or in other words combined with or generated in combination with the navigation data generated by the navigation filter. The fusions are performed by predicting the bearing and elevation for each corner. Consider the position of corner k in the runway frame

pₖ^{e}=Cₙ^{e}(pᵣⁿ+Cᵣⁿ[s_{L}L/2,s_{W}W/2,]^{T}) (33)

where s_{L} and s_{W} represent the signs (+1, −1) of the particular corner in the runway frame, Cᵣⁿ represents the direction cosine matrix relating the runway frame to the navigation frame. L is the runway length state, and W is the runway width state. The relative position of the corner in the measurement frame is obtained from

p_{k/c}^{m}=Cₑ^{m}(pₖ^{e}−p_{c}^{e}) (34)

The predicted bearing and elevation is then obtained by solving for the bearing and elevation in Eq. (12). By fusing these position measurements of the corners into the navigation performed by the ASN 20 and transforming them to the navigation frame, the position of the runway relative to the aircraft at that point in time is set.

The advantage of coupling the runway tracking to the navigation solution provided by the ASN 20 is that the relative navigation solution remains consistent with the uncertainties in the two solutions. Jumps in the navigation solution caused by changes in GPS constellation are taken into account through the cross-correlation terms in the navigation covariance. This makes the runway track, once it validated or confirmed, much more robust than if it is tracked independently.

Tracking the runway for landing is important during the approach and landing phase as it is important to null any cross-track error so that the aircraft lands on the runway. This is provided by using runway edges detected during the approach. On transition to approach, the turret 32 is pointed along the estimated runway heading direction in the navigation frame. The FDC 70 detects the runway edges and passes them to the ASN subsystem 20. The runway track state (represented by the 4 corners of the extreme runway threshold markings) is then related to the physical edges of the runway in the measurement frame. Considering the corners marked by 1501 and 1502 in FIG. 15 as 1 and 2, by utilizing Eq. (33), but adjusting the width term to account for the edge offset, we obtain the vector between corners 1 and 2 in the measurement frame is obtained as

e_{1,2}^{m}=Cₑ^{m}(p₂^{e}−p₁^{e}) (35)

The FDC 70 detects the edges in pixel coordinates and is able to compute a gradient and intercept of the edge in pixel coordinates. For generality, and referring to Eq. (6), a set of nondimensional measurement frame coordinates is defined as

y̅ₘ=yₘ/xₘ, z̅ₘ=zₘ/xₘ (36)

The FDC 70 computes the slope and intercept in terms of nondimensional pixels by subtracting the principal point coordinates and scaling by the focal length. The measured nondimensional slope and intercept of a runway edge is predicted by projecting the relative corners 1 and 2 into the measurement frame and scaling the y and z components by the x-component according to Eq. (36). The slope and intercept are computed from the two corner points, and it does not matter whether the two corner points are actually visible in the frame for this computation. The runway edge is then used as a measurement to update the filter state by using the measured slope and intercept of the edge and a Jacobian transformation.

### Return-To-Base (RTB) Generation

Once the landing system 10 has confirmed that the candidate runway is the desired and valid one to land on, the APG 60 generates a full RTB waypoint set, which actually is a land on candidate runway waypoint set. The RTB waypoint set generated for the FCC 100 includes an inbound tree, circuit, approach, landing, and abort circuit. All of these sequences are subject to a series of validity checks by the FCC 100 before the RTB set is activated and flown.

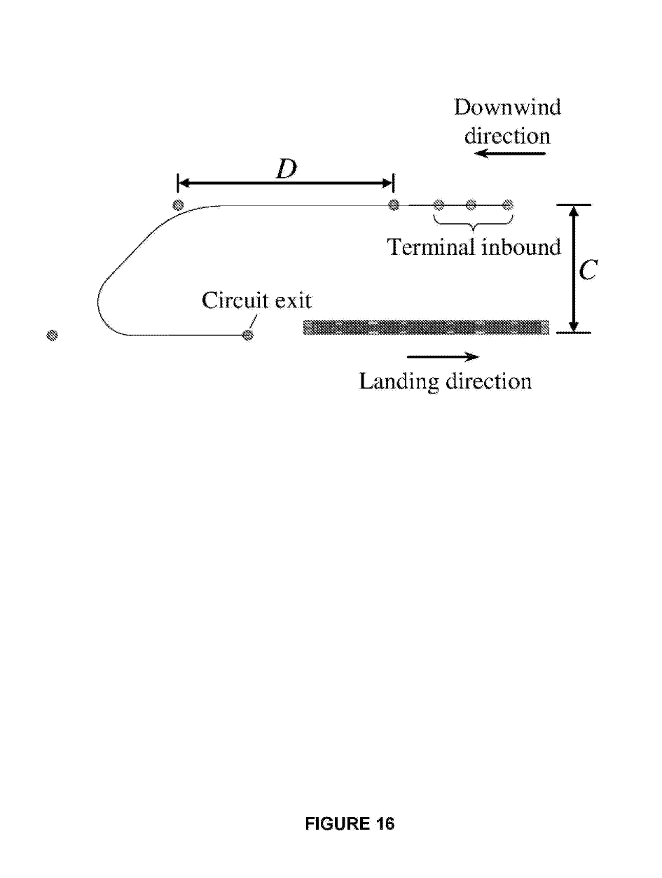

The inbound tree that is generated is a set of waypoints, as shown in FIG. 16, to allow the aircraft to enter into circuit from any flight extent. The FCC traverses the tree from a root node and determines the shortest path through the tree to generate the waypoint sequence for inbound. The AR system generates the tree onboard as a function of the runway location and heading. Because the FCC performs the same checks on the dynamically generated inbound tree as for a static one generated for a mission plan, the AR system uses an inbound waypoint in every flight extent. Also, for every inbound waypoint, the APG 60 needs to generate a flyable sequence from it to the parent or initial inbound point. The parent inbound point is connected to two additional waypoints in a straight line that ensures the aircraft enters into circuit in a consistent and reliable manner. This is important when operating in the vicinity of other aircraft. These two waypoints act as a constraint on the final aircraft heading at the end of the inbound tree.

The inbound tree is generated from a graph of nodes created using the process described in the Routing paper. A set of root inbound nodes are inserted into the graph based on a template constructed in a coordinate frame relative to a generic runway. These root inbound nodes are adjusted as a function of the circuit waypoints, described below. The nodes are rotated into the navigation frame based on the estimated runway heading. A complete inbound tree is found by using the modified Dijkstra's algorithm discussed in the Routing paper, where the goal is to find a waypoint set to take the vehicle from an initial point to a destination point. For the tree construction, the goal is to connect all nodes to the root. By using the modified form of Dijkstra's algorithm, a connected tree is automatically determined since it inherently determines the connections between each node and the destination.

The circuit/abort circuit waypoints are generated from a template with adjustable crosswind, C, and downwind, D, lengths, as shown in FIG. 16. The template is rotated into the NED frame from the runway reference frame, and converted into latitude/longitude/height. The crosswind, C, and downwind, D, lengths are adjusted so as to ensure the circuit waypoints all lie within flight extents. To allow for maximum performance of the runway edge detection, at least one runway length is required between the turn onto final approach and the runway threshold.

### Dynamic Landing Waypoint Control

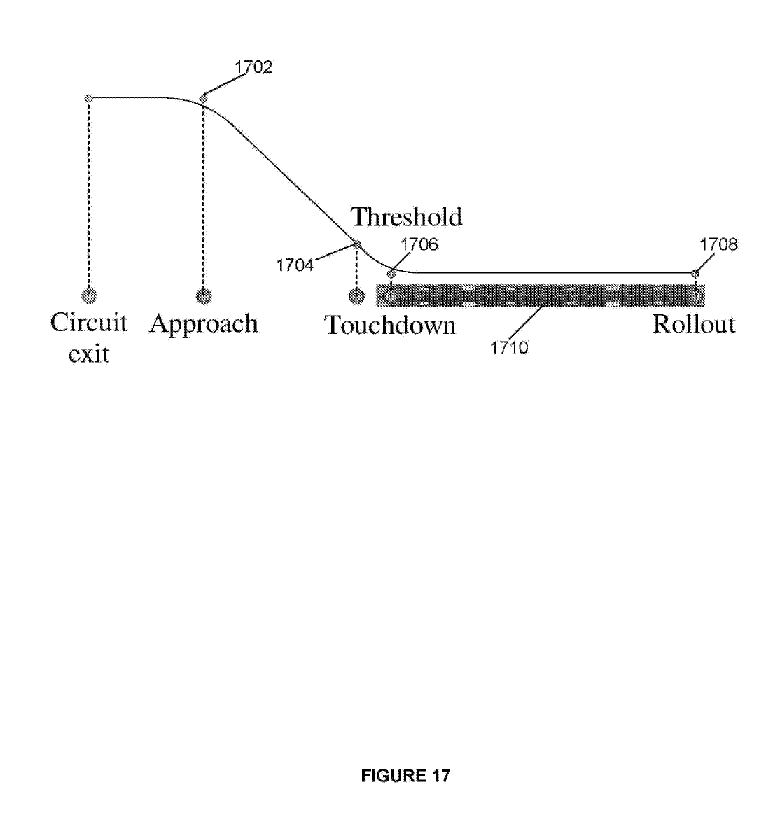

During circuit, approach, and landing, the landing waypoints 1702, 1704, 1706 and 1708 shown in FIG. 17 are updated at 100 Hz, based on the current best estimate of the runway position and orientation. This allows variations in the coupled navigation-runway track to be accounted for by the Guidance CSC on the FCC 100. This is inherently more robust than visual servoing since it does not close-the-loop directly on actual measurements of the runway 1710. For example, if the nose landing gear is blocking the view of the runway, then visual servoing fails, whereas the landing system 10 is still capable of performing a landing.

The four waypoints 1702, 1704, 1706 and 1706 adjusted dynamically are labeled approach, threshold, touchdown and rollout. All four waypoints are required to be in a straight line in the horizontal plane. The approach, threshold and touchdown waypoints are aligned along the glideslope, which can be fixed at 5 degrees.

### Gimbaled Camera

A gimbaled camera 32, 34 on the UAV allows the AR system 50, 60, 70 to control the direction and zoom level of the imagery it is analysing. The turret 32, such as a Rubicon model number AHIR25D, includes an electro-optical (EO) and infrared (IR) camera 34, and is capable of performing full 360 pan and −5 to 95 degrees tilt. The EO camera may be a Sony FCB-EX408C which uses the VISCA binary communication protocol, which is transmitted over an RS-232 to the GEO subsystem 30. Turret control commands are transmitted by the GEO 30 to the Rubicon device 32 using an ASCII protocol, also over RS-232.

### Gimbal Control

The commands sent to the turret 32 are in the form of rate commands about the pan and tilt axes. These are used in a stabilization function on the turret wherein a stabilization mode gyroscopes in the turret and used to mitigate the effects of turbulence on the pointing direction of the camera 34. A velocity control loop is executed on the GEO subsystem 20, which is responsible for control of the turret 32, camera 34, and collecting and forwarding image data and associated meta-data to the FDC 70. The velocity control loop uses pan and tilt commands and closes the loop with measured pan and tilt values. The control loop is able to employ a predictive mechanism to provide for fine angular control.

High-level pointing commands are received by the GEO 30 from the ARC 50. The ARC 50 arbitrates to select from commands issued from a ground controller, the ASN system 20, the FDC 70, and the ARC 50 itself. In all cases, a ground controller has priority and can manually command the turret to move to a specified angle, angular rate, or point at a selected latitude/longitude/height. During autonomous recovery, the turret 32 is commanded to point in a variety of different modes. The turret can be made to “look at” selected points specified in different reference frames (camera frame, body frame. NED frame, ECEF frame). One mode is a bounding box mode that adaptively changes the pointing position and zoom level to fit up to 8 points in the camera field-of-view. This mode is used to point at the desired ends of the runway using the best estimate of the piano keys, and takes into account the uncertainty in their position. A GEO control process of the GEO 30 computes a line of sight and uses a Newton algorithm (a root-finding algorithm to solve for the zeros of a set of nonlinear equations) to iteratively calculate the required pan/tilt angles.

### Zoom Control

Camera zoom is either controlled independently of the pointing command, or coupled to it. The zoom can be set via a direct setting command as a ratio or rate, or can be specified as an equivalent field-of-view measured by its projection onto the ground plane (i.e., units are in meters). This type of control maintains an area in the image quite well by adjusting the zoom level as a function of the navigation position relative to the pointing location. The combined zoom mode uses up to 8 points in the ECEF frame to select a zoom setting such that all 8 points lie within the image.

### Image and Gimbal Timestamp

In addition to running the turret control loop, the GEO subsystem 30 is responsible for capturing still images from the video feed and time stamping the data. The GEO subsystem obtains frequent, e.g. 100 Hz, navigation data from the ASN subsystem 20, and zoom and gimbal measurements from the camera and turret, respectively. These measurements are buffered and interpolated upon receipt of an image timestamp (timestamps are in UTC Time). Euler angles are interpolated by using a rotation vector method.

Navigation data is time stamped according to the UTC Time of an IMU data packet used on a navigation data frame, which is kept in synchronization with GPS time from the GPS unit 180. Gimbal data is time stamped on transmission of a trigger pulse sent by the GEO 30 to the turret 32. The trigger is used by the turret to sample the gimbal angles, which is transmitted to the GEO after it receives a request for the triggered data. Zoom data is time stamped by the GEO on transmission of the zoom request message. Images are time stamped upon receipt of the first byte from a capture card of the GEO 30, and is intercepted on a device driver level. However, this does not provide the time that the image was actually captured by the camera 34. A constant offset is applied that is determined by placing an LED light in front of the camera 34 in a dark room. A static map of pixel location versus pan position was obtained by manually moving the turret to various positions. The turret is then commanded to rotate at various angular rates while simultaneously capturing images. By extracting the position of the LED, and by using the inverse map of pan position, the image capture time can be estimated and compared with the time of arrival of the first image byte. For example, a constant offset of approximately 60 ms between the image capture time and the arrival of the first byte on the GEO can be used.

### CONCLUSION

The landing system 10 differs fundamentally from previous attempts to utilise vision based processes in landing systems. One difference arises from the way the system treats the landing problem. Previous researchers have attempted to land an aircraft by its lateral position relative to information provided from an on-board camera. Unfortunately, this type of approach alone is not only impractical (it relies on somehow lining the aircraft up with the runway a priori), but also dangerous. Any obfuscation of the on-board camera during the final landing phase is usually detrimental. Instead of treating the landing phase in isolation, the landing system 10 adopts a synergistic view of the entire landing sequence. The system 10 seeks out a candidate runway based on a runway data on the aircraft (or obtained from elsewhere using communications on the aircraft), generates a route to the runway, precisely locates the runway on a generated survey route, tracks and validates the runway during vehicle flight and establishes a final approach and landing path.

It is particularly significant that the aircraft is able to use a camera system to obtain images of a candidate runway, and then process those images to detect features of the runway in order to confirm that a candidate landing site includes a valid runway, flight deck or helipad on which the aircraft could land. The images may be obtained from incident radiation of the visual spectrum or infrared radiation, and the FDC is able to use multi-spectral images to detect the extents of the landing site, i.e. corners of a runway. Whilst comparisons can be made with an onboard runway database, candidate sites and runways can be validated without comparison by simply confirming that the detected features correspond to a runway on which the aircraft can land.

Coupling or fusing the runway track initialised and generated by the ARC 50 with the navigation system 20 used by the aircraft also provides a considerable advantage in that the aircraft is able to virtually track the runway along with the navigation data that is provided so as to effectively provide a virtual form of an instrument landing system (ILS) that does not rely upon any ground based infrastructure. This is particularly useful in both manned and unmanned aerial vehicles.

Many modifications will be apparent to those skilled in the art without departing from the scope of the present invention as hereinbefore described.

What is claimed is:

1. A landing system of an aircraft, including:
a site detector controller configured to process images of a candidate site obtained by the aircraft so as to extract feature data of the candidate landing site, and to process the feature data to confirm the candidate site as a landing site;
a navigation system; and
a tracker configured to track the confirmed candidate site using said feature data so as to generate a track of the candidate site relative to the aircraft, and to couple the track to the navigation system so as to land the aircraft.

2. The landing system as claimed in claim 1, further comprising:
a site selector configured to select said candidate site using geographical reference point data for the candidate site and current navigation data generated by the navigation system for the aircraft;
a path generator configured to generate a survey route within a vicinity of said candidate site using said geographical reference point data for the candidate site, and a route to said survey route; and
a camera system configured to obtain said images of the candidate site when said aircraft flies said survey route.

3. The landing system as claimed in claim 2, wherein the path generator is configured to generate survey routes that avoid no fly areas.

4. The landing system as claimed in claim 2, further comprising a database of landing sites, said database including feature data and geographical reference point data for the landing sites, said site selector being configured to select said candidate site from among said landing sites of said database.

5-6. (canceled)

7. The landing system as claimed in claim 1, wherein said landing site is a runway and said feature data represents extents of said runway.

8-9. (canceled)

10. The landing system as claimed in claim 1, wherein the tracker includes a track filter configured to:
process data representing locations of features of said candidate landing site;
initialise and maintain tracks of the features as said track of the candidate site;
compare geometry constraints for a landing site with the track to validate the candidate site as the landing site; and
convert the track into navigation data, representing a position of the landing site, for said navigation system of the aircraft.

11. The landing system as claimed in claim 10, wherein the track includes filter state data used to represent the features of the candidate site.

12. The landing system as claimed in claim 11, wherein the filter state data represents degrees of freedom of movement of the features of the candidate site relative to the aircraft.

13. The landing system as claimed in claim 12, wherein if the landing site is moving, the filter state data represents:
three position states;
a rate of change for each position state;
three attitude states;
a rate of change for each attitude state; and
geometry for features of the candidate site.

14. The landing system as claimed in claim 12, wherein if the landing site is static, the filter state data represents:
at least one camera position; and
depth, bearing and elevation for extents of the landing site relative to the aircraft.

15. The landing system as claimed in claim 13, wherein the filter state data is converted into said navigation data to provide a navigation state representation of the position and features of the landing site in a navigation frame of the navigation system.

16. The landing system as claimed in claim 15, wherein the track is coupled to the navigation system and said navigation state of the landing site is updated during approach and landing.

17. The landing system as claimed in claim 10, wherein the track filter validates the candidate site by processing the track at each of a plurality of state updates to determine whether geometry constraints of the candidate site are within a tolerance for the geometry constraints of the landing site.

18. The landing system as claimed in claim 17, wherein the candidate site is validated as a runway when:
lengths of the runway are within a tolerance;
widths of the runway are within a tolerance;
an alignment of the runway is within a heading tolerance;
a centre of the runway is within a tolerance for north, east and down directions; and
corrections for a specified number of most recent state updates are within a tolerance for extents of the runway.

19. The landing system as claimed in claim 1, wherein said navigation system is configured to land the aircraft on said landing site autonomously, without receiving transmitted emissions from external infrastructure.

20. A landing site detector of an aircraft, comprising a controller configured to process images obtained by the aircraft on a survey route of a candidate landing site, and to extract feature data of the candidate site so as to confirm that the site is a known landing site.

21. The landing site detector as claimed in claim 20, wherein said feature data represents characteristic markings and extents of said landing site.

22. The landing site detector as claimed in claim 21, wherein the extents correspond to corners of a runway and are constrained by a length and a width of the runway.

23. The landing site detector as claimed in claim 22, wherein the extents are determined from detected piano keys of the runway.

24. The landing site detector as claimed in claim 20, wherein said feature data includes coordinates of piano keys of said landing site.

25. An autonomous recovery process, executed by a landing system of an aircraft, comprising:
determining that the aircraft needs to land;
selecting a landing site;
generating a survey route in a vicinity of the landing site;
generating a route that can be taken by the aircraft from its current position to said vicinity of the landing site;
controlling a camera of the aircraft when flying said survey route to obtain images of at least part of the landing site;
processing the images to extract features of said landing site;
using said features to confirm said landing site,
generating a track of the confirmed landing site using said features;
verifying that the track satisfies constraints required for a validated landing site; and
inserting the track into a navigation system of the aircraft.

26. The process as claimed in claim 25, further comprising generating waypoints that enable the aircraft to perform an approach landing.

27. The process as claimed in claim 26, further comprising executing said waypoints and augmenting said landing by using the landing site track inserted into the navigation system as navigation coordinates for the landing site.

28-29. (canceled)
